(19) United States
(12) Patent Application Publication
(10) Pub. No.: US 2017/0010396 A1
(43) Pub. Date: Jan. 12, 2017

(54) OPTICAL FILM

(71) Applicant: KONICA MINOLTA, INC., Tokyo (JP)

(72) Inventors: Hirokazu Koyama, Tokyo (JP); Hiroshi Kita, Tokyo (JP); Kiyoshi Fukusaka, Tokyo (JP); Hiroyoshi Kiuchi, Tokyo (JP)

(73) Assignee: Konica Minolta, Inc., Tokyo (JP)

(21) Appl. No.: 15/113,729

(22) PCT Filed: Jan. 23, 2015
(86) PCT No.: PCT/JP2015/051839

§ 371 Date: Jul. 22, 2016

(30) Foreign Application Priority Data
Jan. 29, 2014 (JP) 2014-014248

(51) Int. Cl. G02B 5/28; G02B 1/14

(52) U.S. Cl. CPC G02B 5/287; G02B 1/14

(57) ABSTRACT

An optical film includes an optical functional layer on a supporting body containing a cellulose derivative as a major component. The optical functional layer is disposed on at least one surface of a film-like supporting body. The supporting body contains a cellulose derivative having an enhanced breaking elongation, and the supporting body has a breaking elongation of 110% or more of the breaking elongation of a supporting body containing a cellulose derivative whose breaking elongation is not enhanced.

### TECHNICAL FIELD

The invention relates to an optical film. Specifically, the invention relates to an optical film having an optical functional layer on a supporting body containing a cellulose derivative as a major component, which is an optical film in which the preserving property of the optical functional layer has been specifically improved.

### BACKGROUND

An optical film containing a cellulose derivative as a major component has a high visible light transmittance, that is, the optical film is excellent in transparency, and also has surface smoothness, and fine appearance and optical properties such as little birefringence, and thus may be used as a polarizing plate protective film disposed on a liquid crystal display.

A film including a cellulose derivative as a major component in such way has an excellent optical property, and thus may be used as a supporting body for an optical film having an optical functional layer such as an infrared ray shielding layer or a colored layer, but the film has not been put into practical use yet, except for some commercial products.

When an optical film containing a cellulose derivative as a major component was used as a supporting body for an optical film having an optical functional layer such as an infrared ray shield layer or a colored layer, it was found that, when the optical film is exposed under an environment where dew condensation and temperature change are repeated by the irradiation with solar light for a long period, the optical properties of the optical functional layer such as reflectance, transmittance and haze are deteriorated.

When the cause thereof was considered, it was found that, in the optical film containing a cellulose derivative as a major component, the stretch of the film easily occurs due to temperature and humidity under the above-mentioned environment, and the stress due to the stretch acts on the optical functional layer and induces distortion on the optical functional layer, and thus decreasing of the reflectance and transmittance, and increasing of the haze occur.

Furthermore, it was also found that fine cracks are generated in the optical film itself by the above-mentioned stretching, and moisture that has become easy to permeate by the cracks further promotes the deterioration of the optical functional layer.

Accordingly, the physical strength of the optical film containing a cellulose derivative as a major component may be enhanced.

It has been known in the conventional polarizing plate protective films to enhance the breaking elongation (also referred to as a breaking point elongation or a tear strength) of a cellulose derivative, and for example, the techniques disclosed in Patent Literatures 1 to 4 can be exemplified.

However, these techniques are techniques for improving tear strength so as to respond to the demand of thinning of polarizing plate protective films, and were not able to express a sufficient effect on supporting bodies having an optical functional layer, which are exposed to severe environments such that dew condensation and temperature change are repeated for a long period.

### CITATION LIST

### Patent Literature

### Patent Literature 1: JP 2004-188679 A

### Patent Literature 2: JP 2004-292696 A

### Patent Literature 3: JP 2009-204834 A

### Patent Literature 4: WO 2006/090700 A

### SUMMARY

Embodiments of the invention provide an optical film having an optical functional layer on a supporting body containing a cellulose derivative as a major component, specifically an optical film wherein the preserving property of the optical functional layer has been improved.

Embodiments of the invention include an optical film having an optical functional layer having an improved preserving property obtained by an optical film having an optical functional layer on at least one surface of a supporting body, wherein the supporting body contains a cellulose derivative having a breaking elongation that has been enhanced to be within a specific range of values.

Specifically, embodiments of the invention provide:

1. An optical film having an optical functional layer on at least one surface of a film-like supporting body, wherein the supporting body contains a cellulose derivative having an enhanced breaking elongation, and the supporting body has a breaking elongation of 110% or more of the breaking elongation of a supporting body containing a cellulose derivative whose breaking elongation is not enhanced.

2. The optical film according to Item. 1, wherein the optical functional layer selectively allows the transmission of or shielding against light at a specific wavelength.

3. The optical film according to Item. 1 or 2, wherein the optical functional layer is a layer that selectively reflects light at a specific wavelength and includes high refractive index layers each containing a first water-soluble binder resin and first metal oxide particles, and low refractive index layers each containing a second water-soluble binder resin and second metal oxide particles, wherein the high refractive index layers and the low refractive index layers are alternately stacked.

4. The optical film according to any one of Items. 1 to 3, wherein the cellulose derivative having an enhanced breaking elongation is a partially chemical-crosslinked cellulose derivative.

5. The optical film according to any one of Items. 1 to 3, wherein the cellulose derivative having an enhanced breaking elongation is such that a part of the hydrogen atoms of the hydroxy groups remaining in the cellulose derivative, which is a major component of the supporting body, have been substituted with substituents, each of which is represented by the following general formula (1):

*-L-A General Formula (1)

(wherein L represents a simple bond, —CO—, —CONH—, —COO—, —SO₂—, —SO₂O—, —SO—, an alkylene group, an alkylene group or an alkynylene group; A represents an aryl group or a heteroaryl group; and the asterisk (*) represents a bonding point between the oxygen atom of the hydroxy group remaining in the cellulose derivative and L.)

6. The optical film according to any one of Items. 1 to 3, wherein the cellulose derivative having an enhanced breaking elongation is a mixture of a cellulose derivative and a thermoplastic resin, and the thermoplastic resin has a hydroxy group, an amide group, an ester group, an ether group, a cyano group or a sulfonyl group as a partial structure in the molecule.

7. The optical film according to any one of Items. 1 to 6, wherein the cellulose derivative is a cellulose ester.

8. The optical film according to any one of Items. 1 to 7, wherein the supporting body has a breaking elongation of 130% or more of the breaking elongation of the supporting body containing a cellulose derivative whose breaking elongation is not enhanced.

9. The optical film according to any one of Items. 1 to 8, wherein the supporting body has a breaking elongation of 150% or more of the breaking elongation of the supporting body containing a cellulose derivative whose breaking elongation is not enhanced.

Embodiments of the invention include an optical film having an optical functional layer on a supporting body containing a cellulose derivative as a major component, specifically an optical film having an optical functional layer having an improved preserving property can be provided.

The action and mechanism, by which the preserving property of the optical functional layer can be improved by using the supporting body containing a cellulose derivative having an enhanced breaking elongation in accordance with embodiments of the invention, are conjectured as follows, but the details thereof have not been clarified.

Firstly, when the advantages of triacetyl cellulose (also referred to as TAC in the present application), which is used as a cellulose derivative in polarizing plate protective films, are considered, since triacetyl cellulose has a chemical structure that is completely free from aromatic components, the absorption of near-ultraviolet ray at 200 to 400 nm is extremely small. Furthermore, due to this, triacetyl cellulose has excellent optical properties of small birefringence and a high visible light transmittance, and these properties depend to a large extent on the above-mentioned chemical structure.

On the other hand, since the interaction among the main chain and the main chain in triacetyl cellulose is substantially only an intermolecular hydrogen bond that is expressed between a hydroxy group and an ester, unsubstituted remaining hydroxy groups are small, and the main chain structure is rigid, it is considered that the probability of formation of a hydrogen bonding between the main chains is low.

Accordingly, there are many hydrophilic sites that are not subjected to hydrogen bonding in triacetyl cellulose, and the bonding between the molecular chains is weak. Therefore, a large amount of moisture is adsorbed and desorbed on the hydrophilic part thereof due to the change in environment. It is also conjectured that, at this time, a substrate is greatly stretched to thereby give a physical damage that induces distortion and the like to the optical functional layer, and the moisture accumulated in the supporting body is gradually released; therefore, the moisture is continuously fed to the optical functional layer, and this moisture promotes the deterioration of the functional layer.

In addition, it is conjectured that, since the bonding among the molecular chains is weak, the low molecular weight components in the supporting body would also easily transfer, and lower the preserving property of the optical functional layer by dispersing in the optical functional layer, and the like.

Furthermore, it is considered that, under a severe environment in which the temperature and humidity rapidly change, fine cracks occur in the supporting body, and moisture easily permeates, since the cellulose derivative itself has a relatively brittle property, and the permeated moisture acts on the optical functional layer.

For the cellulose derivative having a breaking elongation that has been enhanced to a predetermined one or more, the method for the enhancement will be mentioned below. In this cellulose derivative, the bonding among the molecular chains has been strengthened and the physical strength has been improved. Therefore, the stretching due to temperature and humidity is small, and since the adsorption of moisture can be significantly suppressed, the stretch of the supporting body due to adsorption and desorption of moisture is small. Therefore, the content of the moisture that adversely affects the optical functional layer can also be decreased and thus the effect thereof can also be decreased, and the transfer of the low molecular weight components in the supporting body can also be decreased. Furthermore, it is also conjectured that, since the above-mentioned bonding among the molecular chains is strong, the strength of the supporting body is improved and thus the generation of cracks is suppressed, and thus the preserving property of the optical functional layer can be generally improved.

### BRIEF DESCRIPTION OF DRAWINGS

FIG. 1 is a schematic cross-sectional drawing showing an example of the constitution of the optical film in accordance with one or more embodiments of the invention having a reflective layer by a multilayer film.

FIG. 2 is a schematic cross-sectional drawing showing another example of the constitution of the optical film in accordance with one or more embodiments of the invention having a reflective layer by a multilayer film.

### DETAILED DESCRIPTION

An optical film in accordance with embodiments of the invention is an optical film having an optical functional layer on at least one surface of a film-like supporting body, wherein the supporting body contains a cellulose derivative having an enhanced breaking elongation, and the supporting body has a breaking elongation of 110% or more of the breaking elongation of a supporting body containing a cellulose derivative whose breaking elongation is not enhanced. This feature is a technical feature that is common in accordance with embodiments of the invention.

As an embodiment of the present invention, in view of the exertion of the effect of embodiments of the invention, the optical functional layer is a functional layer that selectively allows the transmission of or shielding against light at a specific wavelength, and that the optical functional layer is a layer that selectively reflects light at a specific wavelength and includes high refractive index layers each containing a first water-soluble binder resin and first metal oxide particles, and low refractive index layers each containing a second water-soluble binder resin and second metal oxide particles, and the high refractive index layers and the low refractive index layers are alternately stacked.

The above-mentioned cellulose derivative having an enhanced breaking elongation in accordance with embodiments of the invention may be a partially chemical-crosslinked cellulose derivative, since the adsorption and desorption of moisture in the cellulose derivative at the hydrophilic part can be suppressed, and thus the effect of the moisture from the supporting body on the optical functional layer can be decreased. Furthermore, the stretch of the supporting body in accordance with the adsorption and desorption of the moisture is suppressed, and the generation of a stress on the optical functional layer is suppressed, and thus the decrease in the reflectance and transmittance of the optical functional layer and the increase in the haze can be suppressed.

Furthermore, the above-mentioned cellulose derivative having an enhanced breaking elongation is such that a part of the hydrogen atoms of the hydroxy groups remaining in the cellulose derivative, which is a major component of the supporting body, have been substituted with substituents, each of which is represented by the above-mentioned general formula (1).

Furthermore, the above-mentioned cellulose derivative having an enhanced breaking elongation is a mixture of a cellulose derivative and a thermoplastic resin, and the thermoplastic resin has a hydroxy group, an amide group, an ester group, an ether group, a cyano group or a sulfonyl group as a partial structure in the molecule, since a similar effect to that mentioned above can be enhanced.

The cellulose derivative in accordance with embodiments of the invention may be a cellulose ester in view of optical property, handling property and cost.

Furthermore, the above-mentioned supporting body has a breaking elongation of 130% or more, may be 150% or more of the breaking elongation of the supporting body containing a cellulose derivative whose breaking elongation is not enhanced.

Embodiments of the invention and the constitutional elements thereof, and the forms and embodiments for conducting the invention will be explained below in detail. Incidentally, in the present application, “to” is used by the meaning that the numerical values before and after the word are encompassed as the lower limit value and the upper limit value.

<<Summary of Optical Film of Embodiments of Invention>>

The optical film in accordance with embodiments of the invention is an optical film having an optical functional layer on at least one surface of a film-like supporting body, wherein the supporting body contains a cellulose derivative having an enhanced breaking elongation, and the supporting body has a breaking elongation of 110% or more of the breaking elongation of a supporting body containing a cellulose derivative whose breaking elongation is not enhanced, and such constitution can provide an optical film that utilizes the excellent advantage of the cellulose derivative as the supporting body and has an improved preserving property of the optical functional layer.

<Breaking Elongation>

The breaking elongation represents the maximum force (tensile strength) at which the film can withstand when being stretched and the degree of the stretching during the stretch (tensile stretch).

Specifically, the breaking elongation refers to the stretch immediately before breakage between predetermined gauge marks on a test piece in a tensile test. After the breakage, a part restores as elastic distortion, and other remains in the material as permanent distortion or residual distortion. The unit is represented by %.

The measurement method is conducted according to JIS K 7127 or ASTM-D-882.

The breaking elongation in embodiments of the invention can be measured by, for example, casting a dope formed by dissolving the cellulose derivative in a solvent so as to give a suitable dry film thickness for the measurement, forming a film, and measuring the breaking elongation by using the obtained sample film by using a commercially available tensile tester. An example of the specific method for measuring the breaking elongation will be explained below, but the present application is not limited by this method.

<Measurement of Breaking Elongation>

Fifteen parts by mass of a cellulose derivative for a test, 78 parts by mass of methylene chloride and 7 parts by mass of methanol are put into a sealable container, the mixture is dissolved over 24 hours with slowly stirring, and this dope is filtered under pressurization and further allowed to stand still for 24 hours.

The above-mentioned dope is casted onto a glass plate by using a bar coater at a dope temperature of 30° C. The casted glass plate was tightly sealed and allowed to stand still for 2 minutes so as to make the surface homogeneous (leveling). After the leveling, the glass plate was dried in a hot air drier at 40° C. for 8 minutes, the film was peeled from the glass plate, and the film is then supported by a stainless frame and dried in a hot air drier at 100° C. for 20 minutes to give a film having a film thickness of 50 μm.

The obtained film is left under an environment of 23° C. and 55% RH for 24 hours. The film is cut into a width of 25 mm and stretched by using a temperature-variable tensile tester (for example, Shimadzu Autograph AGS-1000 manufactured by Shimadzu Corporation) under an environment at 23° C. and 55% RH at a distance between chucks of 100 mm and a tensile velocity of 300 mm/min, and the strength at which the sample is cut (broken) (a value obtained by dividing a tensile load value by a cross-sectional surface of a test piece) and the elongation are obtained. The breaking elongation is calculated by the following formula. Incidentally, five test pieces are prepared for the film formation direction, and five test pieces are prepared for the width direction, respectively, and the test pieces are measured, and the average value of the ten test pieces is deemed as the breaking elongation.

Breaking elongation (%)=(L−Lo)/Lo×100

Lo: sample length before test
L: sample length at breakage

### <Supporting Body Containing Cellulose Derivative Having Enhanced Breaking Elongation>

It is necessary that the supporting body containing the cellulose derivative in embodiments of the invention has a breaking elongation that has been enhanced to 110% or more of the breaking elongation of a supporting body containing a cellulose derivative whose breaking elongation is not enhanced, in obtaining the effect of embodiments of the invention.

The degree of the enhancement of the above-mentioned breaking elongation is obtained by the following formula.

Rate of enhancement of breaking elongation (%)=(breaking elongation of supporting body containing cellulose derivative having enhanced breaking elongation)/(breaking elongation of supporting body containing same kind of cellulose derivative whose breaking elongation is not enhanced)×100

In a cellulose derivative having a rate of enhancement of breaking elongation of lower than 110%, when an optical film using a supporting body containing the cellulose derivative is put under the above-mentioned environment, the film is easily stretched due to the variation in temperature and humidity, the stress caused by the stretch acts on an optical functional layer and induces distortion in the optical functional layer; thus, decrease in reflectance and transmittance, and increase in haze occur. Furthermore, in accordance with this stretching, fine cracks are generated in the optical film itself and thus moisture permeates into the optical functional layer, whereby the deterioration of the optical functional layer is further promoted.

The above-mentioned effect of the enhancement of the breaking elongation is such that the breaking elongation has been enhanced by 130% or more, may be by 150% or more, from the viewpoint of improvement of the preserving property of the optical functional layer.

Furthermore, the breaking elongation may be 45% or more, may be 50% or more, may be 60% or more, or may be 70% or more, from the viewpoint of exerting the above-mentioned effect of embodiments of the invention. The breaking elongation of the supporting body in embodiments of the invention is adjusted by suitably adopting a method for chemical-crosslinking the main chains of cellulose, which will be mentioned below, a method for modifying a cellulose derivative, a method for mixing a cellulose derivative with a substance having a soft segment, and the like, singly or in combination.

<<Constitution of Optical Film of Embodiments of the Invention>>

The constitutional elements of the optical film of embodiments of the invention will be sequentially explained below.

<Cellulose Derivative>

The cellulose derivative in embodiments of the invention includes a cellulose ester or a cellulose ether or the like. The above-mentioned cellulose derivative is such that at least a part of the hydrogen atoms of the hydroxy groups at the 2-, 3- and 6-positions of the β-glucose ring contained in cellulose have been substituted with aliphatic acyl groups and/or alkyl groups. Specific cellulose esters include triacetyl cellulose, diacetyl cellulose, cellulose acetate propionate, cellulose acetate butyrate, cellulose tripropionate and the like.

Specific cellulose ethers include methyl cellulose, ethyl cellulose, propyl cellulose, butyl cellulose, allyl cellulose, hydroxyethylmethyl cellulose, hydroxyethylethyl cellulose, hydroxyethylpropyl cellulose, hydroxyethylallyl cellulose and the like.

Cellulose esters are may be used, and triacetyl cellulose, diacetyl cellulose, cellulose acetate propionate and cellulose acetate butyrate may also be used.

The cellulose as a raw material of the above-mentioned cellulose derivative is not specifically limited, and cotton linter, wood pulp, kenaf and the like can be exemplified. Furthermore, each of the cellulose derivatives obtained from these can be used singly, or the cellulose derivatives can be used by mixing at an optional ratio.

When the molecular weight of the above-mentioned cellulose derivative is too small, the film becomes brittle, whereas when the molecular weight is too high, the solubility in a solvent is poor, and the solid content concentration of the resin solution is lowered and thus the use amount of the solvent increases.

Therefore, the molecular weight of the cellulose ester is such that the number average molecular weight Mn may be within the range of from 20,000 to 300,000, may be within the range of from 40,000 to 200,000. Furthermore, the weight average molecular weight (Mw) may be within the range of from 80,000 to 1,000,000, may be within the range of from 100,000 to 500,000, may be within the range of from 150,000 to 300,000. The ratio (Mw/Mn) of the weight average molecular weight (Mw) to the number average molecular weight (Mn) is within the range of from 1.4 to 4.0, may be within the range of from 1.5 to 3.5.

The weight average molecular weight (Mw) and number average molecular weight (Mn) of the cellulose ester can be measured by gel permeation chromatography (GPC). Examples of the measurement conditions will be shown below, but the conditions are not limited to these, and equivalent measurement methods can also be used.

Solvent: methylene chloride

Column: Shodex K806, K805, K803G (manufactured by Showa Denko K. K., three pieces are connected and used)

Column temperature: 25° C.

Sample concentration: 0.1% by mass

Detector: RI Model 504 (manufactured by GL Science)

Pump: L6000 (manufactured by Hitachi, Ltd.)

Flow amount: 1.0 ml/min

Calibration curve: standard polystyrene STK standard polystyrene (manufactured by Tosoh Corporation) A calibrate curve by 13 samples with Mw=500 to 1,000,000 is used. The 13 samples are used at approximately equal intervals.

<Cellulose Derivative Having an Enhanced Breaking Elongation>

The cellulose derivative having an enhanced breaking elongation in embodiments of the invention is the above-mentioned cellulose derivative whose breaking elongation has been increased, and the cellulose derivative whose breaking elongation has been increased is required to have a breaking elongation of 110% or more, may be 130% or more, may be 150% or more, or may be 200% or more of the breaking elongation of a cellulose derivative whose breaking elongation is not enhanced. The upper limit is not specifically limited, but may be 300% or less in view of the effect of the means for enhancing the breaking elongation, and the producibility.

The method for enhancing the breaking elongation of the cellulose derivative is not specifically limited, and a method for chemically crosslinking the main chains of cellulose, a method for introducing aromatic sites into a cellulose derivative itself to thereby impart interactions relating to π electrons (π-π interaction, CH-π interaction and the like), and a method for using together a substance having a so-called soft segment, which highly interacts and is compatible with the cellulose derivative as a major component, and the substance itself is soft, can be utilized.

An example of the method for enhancing the breaking elongation will be explained below. However, embodiments of the invention are not limited by this method.

(1) Chemical-Crosslinked Cellulose Derivative

The chemical-crosslinked cellulose derivative as referred to in embodiments of the invention is, for example, a cellulose derivative in which the remaining hydroxy groups of the cellulose derivative or the carbon atoms contained in the cellulose derivative have been partially crosslinked by covalent bonds, by a crosslinking agent having at least two or more functional groups that can react with the remaining hydroxy groups of the cellulose derivative, or a crosslinking agent having vinyl groups. By using the above-mentioned crosslinking agent having vinyl groups, radicals by the cleavage of the vinyl groups generate by heating and/or ultraviolet irradiation or the like, and the radicals partially draw the hydrogen atoms possessed by the cellulose derivative, specifically the hydrogen atoms on the tertiary carbon atoms, and the like, whereby the cellulose derivatives can be partially crosslinked by covalent bonds by the generated radical sites of the cellulose derivative, or the crosslinking agent having vinyl groups.

Furthermore, examples of the functional groups that can react with the unreacted hydroxy groups of the cellulose derivative can include a formyl group, an isocyanate group, a thioisocyanate group, a carboxy group, a chlorocarbonyl group, an acid anhydride group, a sulfonic acid group, a chlorosulfonyl group, a sulfinic acid group, a chlorosulfonyl group, an epoxy group, a vinyl group, halogen atoms, ester groups, sulfonate ester groups, carbonate ester groups, an amide group, an imide group, carboxylates, sulfonates, phosphates, phosphonates and the like. An epoxy group, ester groups, a formyl group, an isocyanate group, a thioisocyanate group and a carboxy group may be used, and an epoxy group, an isocyanate group and a thioisocyanate group may also be used. The crosslinking agents having these functional groups may be used singly, or may be used in combination of two or more kinds.

Alternatively, as another method, using a compound that has a functional group capable of reacting with the remaining hydroxy groups of the cellulose derivative and has a polymerizable group, the cellulose derivative may be crosslinked with covalent bonds by reacting this compound with the remaining hydroxy groups of the cellulose derivative, and then polymerizing the polymerizable groups. Examples of the functional group capable of reacting with the remaining hydroxy groups of the cellulose derivative are as mentioned above, and include a formyl group, an isocyanate group, a thioisocyanate group, a carboxy group, a chlorocarbonyl group, acid anhydride groups, a sulfonic acid group, a chlorosulfonyl group, a sulfinic acid group, a chlorosulfonyl group, an epoxy group, a glycidyl group, a vinyl group, halogen atoms, ester groups, sulfonate ester groups, carbonate ester groups, amide groups, imide groups, carboxylates, sulfonates, phosphates, phosphonates and the like, and a chlorocarbonyl group, acid anhydride groups, an isocyanate group, a thioisocyanate group, a glycidyl group and an epoxy group may be used.

Examples of the polymerizable group include groups such as a styryl group, an allyl group, a vinylbenzyl group, a vinyl ether group, a vinylketone group, a vinyl group, an isopropenyl group, an acryloyl group, a methacryloyl group, a glycidyl group and an epoxy group.

Examples of the crosslinking agent in embodiments of the invention can include (meth)acrylic acid esters of polyester resins, (meth)acrylic acid esters of polyether resins such as polyethylene glycol di(meth)acrylate and polypropylene glycol di(meth)acrylate, divinyl compounds, aldehyde compounds such as monoaldehydes represented as formaldehyde, and dialdehydes, isocyanate compounds such as 2-(meth)acryloyloxyethylisocyanate, trylene diisocyanate, 4,4′-diphenylmethane diisocyanate, hexamethylene diisocyanate, xylylene diisocyanate, metaxylylene diisocyanate, 1,5-naphthalene diisocyanate, hydrogenated diphenylmethane diisocyanate, hydrogenated trylene diisocyanate, hydrogenated xylylene diisocyanate and isophoron diisocyanate; biuret polyisocyanate compounds such as Sumidur N (manufactured by Sumika Bayer Urethane); polyisocyanate compounds each having a isocyanulate ring such as Desmodur IL and HL (manufactured by Bayer A.G.) and Coronate EH (manufactured by Nippon Polyurethane Industry Co., Ltd.); adduct polyisocyanate compounds such as Sumidur L (manufactured by Sumika Bayer Urethane), adduct polyisocyanate compounds such as coronate HL (manufactured by Nippon Polyurethane Industry Co., Ltd.) and Crisvon NX (manufactured by DIC Corporation), and the like. These can be used singly or in combination of two or more kinds. Alternatively, a block isocyanate may also be used. In addition, examples include inorganic crosslinking agents such as metal oxides such as aluminum oxide, boron compounds and cobalt oxide, phosphoric acid or phosphate esters such as phosphoric acid, monomethyl phosphate, monoethyl phosphate, monobutyl phosphate, monooctyl phosphate, monodecyl phosphate, dimethyl phosphate, diethyl phosphate, dibutyl phosphate, dioctyl phosphate and didecyl phosphate; propylene oxide, butylene oxide, cyclohexene oxide, glycidyl methacrylate, glycidol, acryl glycidyl ether, γ-glycidoxypropyl trimethoxysilane, γ-glycidoxypropyl triethoxysilane, γ-glycidoxypropylmethyl dimethoxysilane, (3,4-epoxycyclohexyl)ethyl trimethoxysilane, commercially available products of diglycidyl ethers of bisphenol A such as Epicoat 827, Epicoat 828, Epicoat 834, Epicoat 1001, Epicoat 1004, Epicoat 1007, Epicoat 1009 and Epicoat 825 (these are trade names, manufactured by Yuka Shell Epoxy K. K.), Araldite GY250 and Araldite GY6099 (these are trade names, manufactured by BASF Japan), ERL2774 (trade name, manufactured by Union Carbide), DER332, DER331 and DER661 (these are trade names, manufactured by Dow Chemical) and the like. Commercially available products of epoxyphenol novolaks such as Epicoat 152 and Epicoat 154 (these are trade names, manufactured by Yuka Shell Epoxy K. K.), DEN438 and DEN448 (these are trade names, manufactured by Dow Chemical), Araldite EPN1138 and Araldite EPN1139 (these are trade names, manufactured by BASF Japan) and the like; commercially available products of epoxycresol novolak such as Araldite ECN1235, Araldite ECN1273 and Araldite ECN1280 (these are trade names, manufactured by BASF Japan) and the like; commercially available products of bromated epoxy resins such as Epicoat 5050 (trade name, manufactured by Yuka Shell Epoxy K. K.), BREN (trade name, manufactured by Nippon Kayaku Co., Ltd.) and the like, and the following compounds are exemplified.

The following compounds can be exemplified, but the crosslinking agent is not limited to these.

Diglycidyl ethers of bisphenol F (diglycidyl esters obtained by reacting a dibasic acid such as phthalic acid, dihydrophthalic acid and tetrahydrophthalic acid with epihalohydrin)

Epoxy compounds obtained by reacting an aromatic amine such as aminophenol or bis(4-aminophenyl)methane with epihalohydrin

1,1,1,3,3,3-Hexafluoro-2,2-[4-(2,3-epoxypropoxy)phenyl]propane

Cyclic aliphatic epoxy compounds obtained by reacting dicyclopentadiene and the like and peracetic acid and the like

1,4-Butanediol diglycidyl ether

1,6-Hexanediol diglycidyl ether

Epicoat 604 (trade name, manufactured by Yuka Shell Epoxy K. K.)

The crosslinking agents used for embodiments of the invention may be (meth)acrylic acid esters of polyester resins, (meth)acrylic acid esters of polyether resins, isocyanate compounds and block isocyanate compounds; may be (meth)acrylic acid esters, (meth)acrylic acid esters of polyether resins; or may be (meth)acrylic acid esters of polyether resins. Examples of the (meth)acrylic acid esters of polyether resins include polyethylene glycol (meth)acrylate (A-200, A-400, A-600, A-1000, 1G, 2G, 3G, 4G, 9G, 14G, 23G and the like, manufactured by Shin-Nakamura Chemical Co., Ltd.), polypropylene glycol (meth)acrylate (APG-100, APG-200, APG-400, APG-700, 3PG, 9PG and the like, manufactured by Shin-Nakamura Chemical Co., Ltd.), polyethylene glycols and polypropylene glycol (meth)acrylates (block type) (A-1206PE, A-0612PE, A-0412PE, 1206PE and the like, manufactured by Shin-Nakamura Chemical Co., Ltd.), polyethylene glycols and polypropylene glycol (meth)acrylates (random type) (A-1000PER, A-3000PER, 1000PER and the like, manufactured by Shin-Nakamura Chemical Co., Ltd.), and the like.

The addition amount of these crosslinking agents is not specifically limited, and may be in the range from 0.01 to 30% by mass, or may be from 0.1 to 10% by mass with respect to the cellulose derivative in view of film strength and planarity. In the case when the addition amount is lower than 0.01% by mass, the cellulose derivative cannot be sufficiently crosslinked, and thus sufficient heat-resistance and mechanical strength cannot be obtained in some cases, whereas when incorporated by more than 30% by mass, the crosslinking progresses quickly, but the toughness decreases, and thus cracking and the like generate in the crosslinking resin during handling, and poor yield rate may occur.

As the method for crosslinking the cellulose derivative in embodiments of the invention, the cellulose derivative may be crosslinked by means of heat or ultraviolet ray or the like without specifically using an initiator that serves as a catalyst, and where necessary, a radical polymerization catalyst such as azobisisobutyronitrile (AIBN) or benzoyl peroxide (BPO), an anion polymerization catalyst, a cation polymerization catalyst or the like may also be used. Furthermore, in the case when a photopolymerization initiator is used, examples include benzyl ketar derivatives such as benzoin derivative and Irgacure 651, α-hydroxyacetophenone derivatives such as 1-hydroxycyclohexyl phenyl ketone (Irgacure 184), α-aminoacetophenone derivatives such as Irgacure 907, and the like.

(2) Cellulose Derivative in which Apart of Hydrogen Atoms in Remaining Hydroxy Groups have been Substituted

The cellulose derivative in which a part of hydrogen atoms in remaining hydroxy groups have been substituted, which is used in embodiments of the invention, may be substituted by substituent(s) represented by the following general formula (1).

*-L-A General Formula (1)

In the above-mentioned general formula (1), L represents a simple bond, —CO—, —CONH—, —COO—, —SO₂—, —SO₂O—, —SO—, an alkylene group, an alkylene group or an alkynylene group. The linking group represented by L may be —CO—, —CONH—, —COO— or —SO₂—, or may be —CO— or —CONH—. In the case when the cellulose derivative has multiple linking groups, these linking groups may be the same or different.

In the above-mentioned general formula (1), A represents an aryl or a heteroaryl. It is considered that, by introducing an aryl group or a heteroaryl group as A into the cellulose derivative, hydrophobicity is imparted to the cellulose derivative, and furthermore, interacting points having different directions are generated among the polymer chains of the cellulose derivative by the π-interaction possessed by the aryl group or heteroaryl group, and the number of the interacting points is increased. It is presumed that the rigidity of the polymer chains derived from the pyranose ring and remaining hydroxy groups of the cellulose derivative has been relaxed by this way, and thus flexibility has been imparted to the cellulose derivative.

The aryl group or heteroaryl group may be a monocycle or a condensed ring. In the case of a monocycle, the monocycle may be a 5 to 10-membered ring, or may be a 5-membered ring or a 6-membered ring. In the case when the aryl group or heteroaryl group represented by A is a condensed ring, a 2- to 10-cyclic aryl group or heteroaryl group in which 5 to 10-membered rings are condensed, a 2 to 5 cyclic aryl group or heteroaryl group in which 5 to 6-membered rings are condensed, and a bicyclic aryl group or heteroaryl group in which 5 to 6-membered ring are condensed. Examples of the aryl group represented by A can include a phenyl group, a 1-naphthyl group, a 2-naphthyl group, a 1-anthracenyl group, a 2-anthracenyl group, a 9-anthracenyl group and the like. Examples of the heteroaryl group represented by A can include an imidazole group, a pyrazole group, a pyridine group, a pyrimidine group, a pyrazine group, a pyridazine group, a triazole group, a triazine group, an indole group, an indazole group, a purine group, a thiaziazole group, an oxaziazole group, a quinoline group, a phthalazine group, a naphthylidine group, a quinoxaline group, a quinazoline group, a cinnoline group, a pteridine group, an acrydine group, a phenanthroline group, a phenazine group, a tetrazole group, a thiazole group, an oxazole group, a benzimidazole group, a benzoxazole group, a benzothiazole group, an indolenine group, a tetrazaindene group and the like. A may be a 5-membered ring or a 6-membered ring, or may be a phenyl group.

These aryl groups and heteroaryl groups may have substituents, and the substituents are not specifically limited, and examples include various groups such as alkyl groups (for example, a methyl group, an ethyl group, a propyl group, an isopropyl group, a t-butyl group, a pentyl group, a hexyl group, an octyl group, a dodecyl group, a trifluoromethyl group and the like), cycloalkyl groups (for example, a cyclopropyl group, a cyclopentyl group, a cyclohexyl group, an adamantyl group and the like), aryl groups (for example, a phenyl group, a naphthyl group and the like), acylamino groups (for example, an acetylamino group, a benzoylamino group and the like), alkylthio groups (for example, a methylthio group, an ethylthio group and the like), arylthio groups (for example, a phenylthio group, a naphthylthio group and the like), alkenyl groups (for example, a vinyl group, a 2-propenyl group, a 3-butenyl group, a 1-methyl-3-propenyl group, a 3-pentenyl group, a 1-methyl-3-butenyl group, a 4-hexenyl group, a cyclohexenyl group, a styryl group and the like), halogen atoms (for example, a fluorine atom, a chlorine atom, a bromine atom, an iodine atom and the like), alkynyl groups (for example, a propargyl group and the like), heterocyclic groups (for example, a pyridyl group, a thiazolyl group, an oxazolyl group, a pyrazolyl group, an imidazolyl group and the like), alkylsulfonyl groups (for example, a methylsulfonyl group, an ethylsulfonyl group and the like), arylsulfonyl groups (for example, a phenylsulfonyl group, a naphthylsulfonyl group and the like), alkylsulfinyl groups (for example, a methylsulfinyl group and the like), arylsulfinyl groups (for example, a phenylsulfinyl group and the like), a phosphono group, acyl groups (for example, an acetyl group, a pivaloyl group, a benzoyl group and the like), carbamoyl groups (for example, an aminocarbonyl group, a methylaminocarbonyl group, a dimethylaminocarbonyl group, a butylaminocarbonyl group, a cyclohexylaminocarbonyl group, a phenylaminocarbonyl group, a 2-pyridylaminocarbonyl group and the like), sulfamoyl groups (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group, a 2-pyridylaminosulfonyl group and the like), sulfonamide groups (for example, a methanesulfonamide group, a benzenesulfonamide group and the like), a cyano group, alkoxy groups (for example, a methoxy group, an ethoxy group, a propoxy group and the like), aryloxy groups (for example, a phenoxy group, a naphthyloxy group and the like), heterocyclic oxy groups, a siloxy group, acyloxy groups (for example, an acetyloxy group, a benzoyloxy group and the like), a sulfonic acid group, sulfonates, an aminocarbonyloxy group, amino groups (for example, an amino group, an ethylamino group, a dimethylamino group, a butylamino group, a cyclopentylamino group, a 2-ethylhexylamino group, a dodecylamino group and the like), anilino groups (for example, a phenylamino group, a chlorophenylamino group, a toluidino group, an anisidino group, a naphthylamino group, a 2-pyridylamino group and the like), an imide group, ureido groups (for example, a methylureido group, an ethylureido group, a pentylureido group, a cyclohexylureido group, an octylureido group, a dodecylureido group, a phenylureido group, a naphthylureido group, a 2-pyridylaminoureido group and the like), alkoxycarbonylamino groups (for example, a methoxycarbonylamino group, a phenoxycarbonylamino group and the like), alkoxycarbonyl groups (for example, a methoxycarbonyl group, an ethoxycarbonyl group, a phenoxycarbonyl and the like), aryloxycarbonyl groups (for example, a phenoxycarbonyl group and the like), heterocyclic thio groups, a thioureido group, a carboxy group, carboxylates, a hydroxy group, a mercapto group, and a nitro group. These substituents may further be optionally substituted by similar substituents.

In the above-mentioned general formula (1), the asterisk (*) represents a bonding point between the oxygen atom of the hydroxy group remaining in the cellulose derivative and L.

In embodiments of the invention, the method for producing the cellulose derivative in which a part of the hydrogen atoms in the remaining hydroxy group have been substituted with the general formula (1) can be selected from production methods of a single stage or multiple stages.

The single stage production method is such that the synthesis is conducted by esterifying from cellulose, and can be used in the case when the above-mentioned linking group L is —CO—. For example, it is sufficient to conduct the reaction by using, as an esterifying agent (an acid anhydride or an acid halide or the like), a mixture of two or more kinds, or a mixed acid anhydride constituted by two kinds of carboxy groups.

The multiple-stage synthesis method can be applied irrespective of the kind of the above-mentioned linking group L, and is a method for producing an intended compound by esterifying or etherifying cellulose to once synthesize a synthesis intermediate, and using the synthesis intermediate as the starting substance of the next step, reacting an acid chloride, an isocyanate, an acid anhydride or an alkyl halide or the like having the above-mentioned substituent A with the remaining hydroxy groups of the cellulose derivative. The method is useful in the cases when the substitution degree represented by the above-mentioned general formula (1) is to be introduced in an inexpensive compound such as diacetyl cellulose, triacetyl cellulose, propionyl cellulose, butyryl cellulose, cellulose acetate propionate, cellulose acetate butyrate, methyl cellulose, ethyl cellulose, hydroxypropyl methyl cellulose or hydroxypropyl ethyl cellulose. In industrial production methods, there are some cases when, for example, production is conducted by conducting esterification, hydrolysis, decomposition polymerization and the like in a sequential manner without removing intermediates, and such synthesis methods can also be considered to be within the scope of multiple stage synthesis methods.

The substitution degree of the substituent represented by the above-mentioned general formula (1) may be in the range of from 0.1 to 3.0, or may be in the range of from 0.5 to 2.5. If the substitution degree of the substituent represented by the above-mentioned general formula (1) is 0.1 or more, since the content of the aryl group or the heteroaryl group becomes sufficient, and the effect of embodiments of the invention is expressed.

In the cellulose derivative in which a part of the hydrogen atoms in the remaining hydroxy group have been substituted with the general formula (1), the effect of enhancing breaking elongation is improved by incorporating a low molecular weight compound having an aromatic group. The reason therefor is considered that the low molecular weight compound having an aromatic group forms π-interaction between the aryl group or heteroaryl group to thereby increase the interaction points having different directionality which are generated among the polymer chains of the cellulose derivative.

As the low molecular weight compound having an aromatic group, a compound having a molecular weight in the range of from 200 to 1,500 can be used. For example, the ester described in JP 2002-36343 A and the like, the aromatic compounds described in JP 2013-24903 A, JP 2000-111914 A and JP 4447997 B, and the like can be exemplified.

The addition amount of the above-mentioned low molecular weight compound having an aromatic group may be from 0.5 to 30% by mass, or may be from 1 to 10% by mass with respect to the cellulose derivative.

(3) Mixture of Cellulose Derivative and Thermoplastic Resin

The cellulose derivative in embodiments of the invention can enhance the breaking elongation by being mixed with a thermoplastic resin.

As the thermoplastic resin used in the mixture of the cellulose derivative and the thermoplastic resin, thermoplastic resins having a hydroxy group, an amide group, an ester group, an ether group, a cyano group or a sulfonyl group as a partial structure in the molecule may be used. Since the thermoplastic resins having the above-mentioned partial structures have a hydrogen bond and/or a dipolar interaction with the hydroxy group and/or the ester group of the cellulose derivative, the compatibility is improved, and a film having high transparency can be obtained. Furthermore, it becomes possible to impart durability to a film prepared from the mixture of the thermoplastic resin and the cellulose derivative by imparting high compatibility to the mixture of the thermoplastic resin and the cellulose derivative. Although the details of this phenomenon are unclear, the reason therefor is presumed that slight gaps generated during the film preparation are filled with the above-mentioned thermoplastic resin, and the rigidity of the polymer chains derived from the pyranose ring and the residual hydroxy groups of the cellulose derivative is relaxed by the interaction between the above-mentioned thermoplastic resin and the cellulose derivative.

Examples of the thermoplastic resin used in embodiments of the invention can include polyolefin-based resins such as ethylene/vinyl acetate copolymers, ethylene/vinyl acetate copolymer-saponified products, ethylene/acrylic acid copolymers, ethylene/methacrylic acid copolymers, ethylene/methyl acrylate copolymers, ethylene/methyl methacrylate copolymers, ethylene/ethyl acrylate copolymers; polyolefin-based resins obtained by modifying these polyolefin-based resins with carboxy groups of acrylic acid, methacrylic acid, maleic acid, fumaric acid, itaconic acid, crotonic acid, mesaconic acid, citraconic acid and glutacone acid and metal salts thereof, acid anhydrides such as anhydrous maleic acid, anhydrous itaconic acid and anhydrous citraconic acid, compounds having an epoxy group such as glycidyl acrylate, glycidyl itaconate and glycidyl citraconate; polyester-based resins such as polybutylene telephthalate, polyethylene telephthalate, polyethylene naphthalate, polybutylene naphthalate, polyethylene isophthalate and polyarylate; polyether resins such as polyacetal, polyphenylene oxide, polyethylene glycol and polypropylene glycol; polyketone-based resins such as polyether ether ketone and poly allyl ether ketone; polynitrile-based resins such as polyacrylonitrile, polymethacrylonitrile, acrylonitrile/styrene copolymers, acrylonitrile/butadiene/styrene copolymers and methacrylonitrile/butadiene/styrene copolymers; polymethacrylate-based resins such as polymethyl methacrylate and polyethyl methacrylate; polyvinylester-based resins such as polyvinyl acetate; polyvinyl chloride-based resins such as vinylidene chloride/methylacrylate copolymers; polycarbonate-based resins such as polycarbonates; polyimide-based resins such as thermoplastic polyimides, polyamideimides and polyetherimides; thermoplastic polyurethane resins; polyamide-based resins such as polyamide 6, polyamide 66, polyamide 46, polyamide 610, polyamide 612, polymetaxylylene adipamide (MXD6), polyhexamethylene telephthalamide (PA6T), polynonamethylene telephthalamide (PAST), polydecamethylene telephthalamide (PA10T), polydodecamethylene telephthalamide (PA12T) and polybis(4-aminocyclohexyl)methanedodecamide (PACM12), and copolymers using several kinds of polyamide raw material monomers forming these and/or the above-mentioned polyamide raw material monomers. Among these, polyester-based resins, polyether-based resins, methacrylic acid ester-based resins or acrylic acid ester-based resins may be used, and polyether-based resins may be used.

As the polyether-based resins, polyacetals (homopolymers or copolymers of polyoxymethylene), polyethylene glycols, polyethylene glycols with terminals blocked with alkyl groups (one terminal or both terminals may be blocked), polyethylene glycols with terminals blocked with acyl groups (one terminal or both terminals may be blocked), polypropylene glycols, polypropylene glycols with terminals blocked with alkyl groups (one terminal or both terminals may be blocked), polypropylene glycols with terminals blocked with acyl groups (one terminal or both terminals may be blocked), polytetraethylene glycols, polybutylene glycols, block copolymers of polyethylene glycol and polypropylene glycol, random copolymers of ethylene glycol and propylene glycol, and the like can be used.

In embodiments of the invention, the weight average molecular weight of the thermoplastic resin may be within the range of from 1,000 to 1,000,000, may be within the range of from 2,000 to 800,000, or may be within the range of from 5,000 to 500,000.

In the case when the weight average molecular weight is lower than 1,000, a film having excellent compatibility with the cellulose derivative and high transparency can be obtained, but bleed out easily occurs. On the other hand, in the case when the average molecular weight goes beyond 1,000,000, the breaking elongation is improved, but the compatibility with the cellulose derivative is lowered, and the haze is deteriorated. In embodiments of the invention, a film that is excellent in transparency and toughness can be obtained by setting the weight average molecular weight of the thermoplastic resin to be within the above-mentioned range.

<Other Additives>

In the supporting body in embodiments of the invention, particles may be incorporated within the scope where the transparency is not deteriorated, so as to make handling easy. Examples of the particles used in embodiments of the invention can include inorganic particles such as calcium carbonate, calcium phosphate, silica, kaolin, talc, titanium dioxide, alumina, barium sulfate, calcium fluoride, lithium fluoride, zeolite and molybdenum sulfate, and organic particles such as crosslinked polymer particles and calcium oxalate. Furthermore, examples of the method for adding the particles can include a method including adding by incorporating particles in a polyester as a raw material, a method including directly adding the particles to an extruder, and the like, of which either one method may be adopted, or two methods may be used in combination. In embodiments of the invention, where necessary, additives may be added besides the above-mentioned particles. Examples of such additives include stabilizers, lubricants, crosslinking agents, antiblocking agents, antioxidants, dyes, pigments, ultraviolet absorbers and the like.

<<Method for Producing Supporting Body Containing Cellulose Derivative>>

As the method for producing the supporting body containing the cellulose derivative in embodiments of the invention (hereinafter also simply referred to as “supporting body”), production processes such as a general inflation process, T-die process, a calendar process, a cutting process, a casting process, an emulsion process and a hot press process can be used, and in view of suppression of coloring, suppression of disadvantages by foreign substances, suppression of optical disadvantages of die lines and the like, and the like, a solution casting film formation process and a melt casting film formation process can be selected as the film formation method, and a solution casting film formation process may be used from the viewpoint that a homogeneous and smooth surface can be obtained.

A preparation example in which the supporting body in embodiments of the invention is produced by a solution casting process will be explained below.

The supporting body in embodiments of the invention is produced by a step of dissolving at least a cellulose derivative, or a cellulose derivative and a thermoplastic resin, and where necessary, additives and the like in a solvent to prepare a dope and filtering the dope; a step of casting the prepared dope onto a belt-like or drum-like metal supporting body to form a web; a step of removing the formed web from the metal supporting body to form a film-like supporting body; a step of drawing and drying the above-mentioned supporting body; and a step of cooling the dried supporting body and then winding the supporting body in a roll-shape. The supporting body in embodiments of the invention contains the cellulose derivative in the range of from 60 to 95% by mass in the solid content.

The respective steps will be explained below.

(1) Dissolving Step

This is a step of dissolving a cellulose derivative, or the cellulose derivative and a thermoplastic resin, and where necessary, additives and the like in an organic solvent containing mainly a good solvent for the cellulose derivative, with stirring in a dissolution tank to form a dope, or a step of mixing the cellulose derivative solution, with the thermoplastic resin, and where necessary, compound solutions such as additives to give a dope, which is a main solution.

In the case when the supporting body in embodiments of the invention is produced by a solution casting process, as the organic solvent useful for forming the dope, any organic solvent can be used without limitation as long as it is an organic solvent that simultaneously dissolves the cellulose derivative, or the cellulose derivative and the thermoplastic resin, and further the other additives and the like.

Examples of the chlorine-based organic solvent can include methylene chloride, and examples of the non-chlorine-based organic solvent can include methyl acetate, ethyl acetate, amyl acetate, acetone, tetrahydrofuran, 1,3-dioxolane, 1,4-dioxane, cyclohexanone, ethyl formate, 2,2,2-trifluoroethanol, 2,2,3,3-hexafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, nitroethane and the like, and for example, as the main solvent, methylene chloride, methyl acetate, ethyl acetate and acetone can be used, and methylene chloride or ethyl acetate may be used.

A straight chain or branched chain aliphatic alcohol having 1 to 4 carbon atoms in the range from 1 to 40% by mass in the dope besides the above-mentioned organic solvent may be incorporated. If the ratio of the alcohol in the dope is high, the web is gelled and easily removed from the metal supporting body, whereas when the ratio of the alcohol is small, the alcohol also plays a role of promoting the dissolution of the cellulose derivative and the other compounds in the non-chlorine-based organic solvent system. In the film formation of the supporting body in embodiments of the invention, from the viewpoint of increasing the planarity of the obtained supporting body, a method for forming a film by using a dope containing an alcohol at a concentration in the range of from 0.5 to 15.0% by mass can be adopted.

Specifically, a dope composition formed by dissolving the cellulose derivative and the other compounds in the range from 15 to 45% by mass in total in a solvent containing methylene chloride, and a straight chain or branched chain aliphatic alcohol having 1 to 4 carbon atoms may be used.

As the straight chain or branched chain aliphatic alcohol having 1 to 4 carbon atoms, methanol, ethanol, n-propanol, iso-propanol, n-butanol, sec-butanol and tert-butanol can be exemplified. Among these, methanol and ethanol may be used since the stability and boiling point of the dope are relatively low, and the drying property is also fine.

For dissolving the cellulose derivative, the thermoplastic resin or the other compounds, various dissolution methods such as a method in which dissolution is conducted at an ordinary pressure, a method in which dissolution is conducted at the boiling point of the main solvent or less, a method in which dissolution is conducted by pressurizing at the boiling point of the main solvent or more, the method in which dissolution is conducted by a cooling dissolution process described in JP 9-95544 A, JP 9-95557 A or JP 9-95538 A, and the method in which dissolution is conducted at a high pressure described in JP 11-21379 A can be used, and the method in which dissolution is conducted by pressurizing at the boiling point of the main solvent or more may be used.

The concentration of the cellulose derivative in the dope may be in the range of from 10 to 40% by mass. The compounds are added to the dope during or after the dissolution, dissolved and dispersed, and the dispersion is then filtered by means of a filter material, defoamed and sent to the next step by means of a liquid sending pump.

(2) Casting Step

### (2-1) Casting of Dope

This is a step in which the dope is sent to a pressurizing die through a liquid sending pump (for example, a pressurization-type quantification gear pump), and the dope is casted from a slit of the pressurization die on a casting position of a metal supporting body such as an endless metal supporting body that transfers unlimitedly such as a stainless belt or a rotating metal drum.

As the metal supporting body in the casting (cast) step, a metal supporting body having a mirrored surface may be used, and a stainless steel belt or a drum having a surface plated with a cast metal may be used as the metal supporting body. The width of the cast can be in the range of from 1 to 4 m, in the range of from 1.5 to 3 m, or may be in the range of from 2 to 2.8 m. The surface temperature of the metal supporting body in the casting step is preset to from −50° C. to a temperature at which the solvent does not come to a boil and foam or less, may be to the range of from −30 to 0° C. A higher temperature may be used since the drying velocity of a web can be increased, but if the temperature is too high, the web may foam or deteriorate its planarity. A supporting body temperature may be suitably determined at from 0 to 100° C., and the range of from 5 to 30° C. Alternatively, a method to cool the web to thereby allow the web to be gelled, and remove the web in the state of containing a large amount of the residual solvent from the drum. The method for controlling the temperature of the metal supporting body is not specifically limited, and examples include a method including blowing with hot air or cold air, and a method including bringing hot water in contact with the rear surface of the metal supporting body. Hot water may be used since the transmission of heat is conducted efficiently, and thus the time required for the temperature of the metal supporting body to become constant is short. In the case when hot air is used, there is a case when hot air at the boiling point of the solvent or more is used and wind at a temperature that is higher than an intended temperature is used while preventing foaming, with consideration for the decrease in the temperature of the web due to the evaporation latent heat of the solvent. Specifically efficient conducting of drying by changing the temperature of the supporting body and the temperature of the drying wind during casting to peeling may be used.

A pressurizing die, which can adjust the slit shape of the cap part of the die and easily gives an even film thickness. Examples of the pressurizing die include a coat hanger die, a T-die or the like, and each of which may be used. The surface of the metal supporting body is a mirror surface. In order to increase the film formation velocity, two or more pressurizing dies may be disposed on the metal supporting body, and stacking may be conducted by dividing the dope amounts.

(3) Solvent Evaporation Step

This is a step for heating the web (the web refers to a dope film formed by casting a dope on a casting supporting body) on a casting supporting body, and evaporating the solvent.

For evaporating the solvent, a method in which the film is blown by wind from the side of the web, or a method in which heat is transmitted by a liquid from the rear surface of the supporting body, a method in which heat is transmitted from the top and rear surfaces by radiation heat or the like, and the method in which heat is transmitted by a liquid from the rear surface may be used since the drying efficiency is fine. Furthermore, a method including those methods in combination may be used. The web may dry on the supporting body after the casting under an atmosphere of from 40 to 100° C. on the supporting body. In order to maintain under the atmosphere of from 40 to 100° C., the upper surface of the web may be blown with hot air at this temperature, or to heat by a means such as infrared ray.

In view of plane quality, moisture permeability and peelability, the web may be peeled from the supporting body within 30 to 120 seconds.

(4) Peeling Step

This is a step for peeling the web from which the solvent has been evaporated on the metal supporting body at a peeling position. The peeled web is sent to the next step as a film-like supporting body.

The temperature at the peeling position on the metal supporting body may be in the range of from 10 to 40° C., may be in the range of from 11 to 30° C.

Incidentally, the amount of the residual solvent during the peeling of the web on the metal supporting body at the timepoint of the peeling may be such that the peeling is conducted in the range of from 50 to 120% by mass depending on the strength of the conditions of drying, the length of the metal supporting body, and the like. However, in the case when the peeling is conducted at the timepoint when amount of the residual solvent is larger, if the web is too soft, the planarity is deteriorated during the peeling, and cramping by the peeling tension and longitudinal streaks easily generate. Therefore, the amount of the residual solvent during the peeling is determined depending on the balance of economic velocity and quality.

The amount of the residual solvent of the web is defined by the following formula (Z).

Amount of residual solvent (%)=(mass of web before heat treatment−mass of web after heat treatment)/(mass of web after heat treatment)×100 Formula (Z)

The heat treatment in the measurement of the amount of the residual solvent represents a heat treatment at 115° C. for 1 hour.

(5) Drying and Drawing Steps

The drying step can be conducted by dividing into a preliminary drying step and a main drying step.

<Preliminary Drying Step>

The web obtained by peeling from the metal supporting body is dried. The web may be dried while transporting the web by means of many rollers that are disposed on the upper and lower sides, or may be dried while transporting the web by fixing with clips at the both ends of the web as in a tenter drier.

The means for drying the web is not specifically limited, and the drying can be generally conducted by hot air, infrared ray, a heating roller, microwave or the like, and may be conducted by hot air in view of easiness.

The drying temperature for the web in the drying step may be −5° C. or less of the glass transition point of the film, and it is effective for conducting the heat treatment at a temperature of 100° C. or more for 10 minutes or more and 60 minutes or less. The drying is conducted at a drying temperature within the range of from 100 to 200° C., may be within the range of from 110 to 160° C.

<Drawing Step>

In the supporting body in embodiments of the invention, the orientation of the molecules in the film can be controlled by conducting a drawing treatment, and the planarity is improved.

The supporting body may be drawn in the casting direction (also referred to as MD direction) and/or width direction (also referred to as TD direction), and may be produced by drawing in at least the width direction by a tenter drawing device.

The drawing operation can be divided into multiple stages. Alternatively, in the case when biaxial drawing is conducted, the biaxial drawing may be conducted simultaneously, or may be conducted in steps. In this case, in steps refers to, for example, that it is possible to sequentially conduct different drawings in the drawing direction, or it is possible to divide a drawing in the same direction into multiple stages and add a drawing in a different direction to any of those stages.

Specifically, for example, the following drawing steps are possible:

Drawing in the casting direction→drawing in the width direction→drawing in the casting direction→drawing in the casting direction

Drawing in the width direction→drawing in the width direction→drawing in the casting direction→drawing in the casting direction

Furthermore, the simultaneous biaxial drawing also includes the case when drawing is conducted in one direction, and shrinking is conducted in the other direction with relaxing the tension.

The amount of the residual solvent at the time of the initiation of the drawing may be within the range of from 2 to 10% by mass.

If the said amount of the residual solvent is 2% by mass or more, the deviation in film thickness is decreased, in view of planarity, whereas when the amount is within 10% by mass, since the unevenness of the surface is decreased and the planarity is improved.

The supporting body may be drawn in the temperature range of from (Tg+15) to (Tg+50°) C., wherein Tg is a glass transition temperature. When the drawing is conducted in the above-mentioned temperature range, generation of breakage is suppressed, and thus a supporting body that is excellent in the planarity and the colorability of the film itself can be obtained. A drawing temperature may be in the range of from (Tg+20) to (Tg+40°) C.

The glass transition temperature Tg herein is an intermediate glass transition temperature (Tmg) obtained by measuring at a temperature raising rate of 20° C./min in accordance with JIS K7121 (1987) by using a commercially available differential scanning calorimeter. The specific method for measuring the glass transition temperature Tg of the supporting body is such that the measurement is conducted in accordance with JIS K7121 (1987) by using a differential scanning calorimeter DSC220 manufacture by Seiko Instruments Inc.

In the supporting body in embodiments of the invention, the web may be drawn in at least the TD direction by 1.1 times or more. The range of the drawing may be from 1.1 to 1.5 times, may be from 1.2 to 1.4 times with respect to the original width. In the above-mentioned range, the molecules in the film significantly transfer, and thus the film can be formed into a thin film, and the planarity can be improved.

In order to draw in the TD direction, for example, a method as shown in JP 62-46625 A, in which all or a part of drying steps is/are conducted by drying while retaining the both sides of the width by clips or pins in the width direction (this is called as a tenter system) is used, and specifically, a tenter system using clips and a tenter system using pins may be used.

(6) Winding Step

This is a step of winding the supporting body after the amount of the residual solvent in the web has become 2% by mass or less, and by adjusting the amount of the residual solvent to 0.4% by mass or less, a supporting body containing a cellulose derivative having fine size stability can be obtained.

As the winding method, a generally used method may be used, and examples include a constant torque process, a constant tension process, a taper tension process, a program tension control process in which the inner stress is constant, and the like, and those processes may be used depending on the purpose.

<Physical Properties of Supporting Body>

The thickness of the supporting body in embodiments of the invention may be within the range of from 30 to 200 μm, may be within the range of from 30 to 100 μm, may be within the range of from 35 to 70 μm. If the transparent resin film has a thickness of 30 μm or more, wrinkles and the like hardly generate during handling, whereas if the thickness is 200 μm or less, a thin film supporting body that is excellent in handling property and transparency can be provided.

The supporting body in embodiments of the invention may be long, specifically has a length of from about 100 to 10,000 m, and may be wound into a roll shape. Furthermore, the supporting body has a width of preferably 1 m or more, may be 1.4 m or more, or may be from 1.4 to 4 m.

As the optical property of the supporting body in embodiments of the invention, the supporting body has a visible light transmittance measured by JIS R3106 (1998) of 60% or more, may be 70% or more, may be 80% or more.

The haze may be lower than 1%, may be lower than 0.5%. By adjusting the haze to be lower than 1%, there is an advantage that the film has a higher transparency, and thus becomes easier to use as a film for optical use.

The supporting body in embodiments of the invention has an equilibrium water content at 25° C. and a relative humidity of 60% of 4% or less, may be 3% or less. By setting the equilibrium water content to 4% or less, the size is more difficult to change even the temperature and humidity change.

<<Optical Functional Layer>>

The optical functional layer in embodiments of the invention is not specifically limited as long as it is a layer having a function to control an optical property, and examples can include a layer that controls reflectance or transmittance, a layer that changes the direction of light of a microlens, a microprism, a scatter layer or the like, or collects light, or the like, and among these, the optical functional layer can be used as an optical reflective layer that selectively allows the transmission of or shielding against light at a specific wavelength.

As the layer that selectively allows the transmission of or shielding against light at a specific wavelength, a layer that absorbs a specific wavelength by a dye or a pigment, a layer that reflects infrared ray by disposing a metal thin film, a layer in which low refractive index layers and high refractive index layers are alternately stacked to thereby reflect only light at a wavelength in accordance with the film thickness thereof (a reflective layer by a multilayer film) and the like can be exemplified.

Specifically, the layer can be applied to a layer that selectively reflects light at a specific wavelength, which includes high refractive index layers each containing a first water-soluble binder resin and first metal oxide particles, and low refractive index layers each containing a second water-soluble binder resin and second metal oxide particles are alternately stacked. In this method, as the interface mixing of the low refractive index layer and the high refractive index layer is smaller, the interface reflection is further increased and a higher reflectance can be obtained, and the cellulose derivative may be applied to the supporting body, since when the cellulose derivative is used as the supporting body, the cellulose derivative absorbs the solvent during the application, and the solvent can be vaporized from not only the upper surface of the application layer (air side) but also from the side of the supporting body, and thus the application layer is solidified quickly, the interface mixing between the low refractive index layer and the high refractive index layer is decreased, and a high reflectance can be obtained. On the other hand, since the layer constitution is complex and the effect of deterioration during storage easily appears, the supporting body may be applied.

(1) Optical Reflective Layer by Multilayer Film

The optical reflective layer by a multilayer film expresses a function to reflect to thereby shield against solar ray such as an infrared ray component, and is constituted by a plurality of refractive index layers having different refractive indexes. Specifically, the optical reflective layer is constituted by stacking high refractive index layers and low refractive index layers. The optical reflective layer used in embodiments of the invention may be any one as long as it has a constitution containing at least one stacked body (unit) constituted by a high refractive index layer and a low refractive index layer, and may have a constitution in which two or more of the above-mentioned stacked bodies each constituted by a high refractive index layer and a low refractive index layer are stacked. In this case, the uppermost layer and the lowermost layer of the optical reflective layer may be either of a high refractive index layer and a low refractive index layer, and it may be that both of the uppermost layer and the lowermost layer are low refractive index layers. If the uppermost layer is a low refractive index layer, the applicability is improved, and if the lowermost layer is a low refractive index layer, the tight adhesiveness is improved.

Meanwhile, whether the optional refractive index layer of the optical reflective layer is a high refractive index layer or a low refractive index layer is judged by the comparison of the refractive indexes with the adjacent refractive index layer. Specifically, when a certain refractive index layer is set as a standard layer, if the refractive index layer adjacent to this standard layer has a lower refractive index than that of the standard layer, then the standard layer is judged to be a high refractive index layer (the adjacent layer is a low refractive index layer). On the other hand, if the adjacent layer has a higher refractive index than that of the standard layer, then the standard layer is judged to be a low refractive index layer (the adjacent layer is a high refractive index layer). Therefore, whether the refractive index layer is a high refractive index layer or a low refractive index layer is a relative matter that is determined by the relationship with the refractive index possessed by the adjacent layer, and a certain refractive index layer may be either a high refractive index layer or a low refractive index layer depending on the relationship with the adjacent layer.

Meanwhile, there is a case when a component that constitutes a high refractive index layer (hereinafter also referred to as “high refractive index layer component”) and a component that constitutes a low refractive index layer (hereinafter also referred to as “low refractive index layer component”) are mixed at the interface of the two layers to thereby form a layer (mixed layer) containing the high refractive index layer component and the low refractive index layer component. In this case, in the mixed layer, an aggregation of the sites containing the high refractive index layer component by 50% by mass or more is set as a high refractive index layer, and an aggregation of the sites containing the low refractive index layer component by 50% by mass or more is set as a low refractive index layer. Specifically, for example, in the case when the low refractive index layer, for example, the low refractive index layer and the high refractive index layer respectively contain different metal oxide particles, the concentration profiles of the metal oxide particles in the layer thickness direction of a stack film of these are measured, and whether the mixed layer that can be formed is a high refractive index layer or a low refractive index layer can be determined by the composition of the concentration profiles. The concentration profile of the metal oxide particles in the stack film can be observed by conducting etching in the depth direction from the surface and conducting sputtering by using an XPS surface analyzer with setting the uppermost surface to be 0 nm at a velocity of 0.5 nm/min by using a sputtering process, and measuring the atom composition ratio. Furthermore, also in the case when low refractive index component or high refractive index component does not contain metal oxide particles and thus is formed of only a water-soluble resin, the presence of a mixed area is confirmed by measuring, for example, the carbon concentration in the layer thickness direction in the concentration profile of the water-soluble resin in a similar manner, and the composition is further measured by EDX (energy dispersion type X-ray spectrometry), whereby each of the layers etched by sputtering can be deemed as a high refractive index layer or a low refractive index layer.

The XPS surface analyzer is not specifically limited and any device can be used, and ESCALAB-200R manufactured by VG Scientifics was used. Mg is used as an X-ray anode, and the measurement is conducted at an output of 600 W (acceleration voltage 15 kV, emission current 40 mA).

The difference in the refractive indexes of the low refractive index layer and the high refractive index layer may be designed to be great, from the viewpoint that the infrared ray light reflectance or the like can be increased by a small number of layers. In this embodiment, in at least one of the stacked body (unit) constituted by low refractive index layers and high refractive index layers, the difference in the refractive indexes between the adjacent low refractive index layer and high refractive index layer may be 0.1 or more, may be 0.3 or more, may be 0.35 or more, or may be more than 0.4. In the case when the optical reflective layer has two or more stacked bodies (units) of high refractive index layer(s) and low refractive index layer(s), the refractive index differences in the high refractive index layers and the low refractive index layers in all of the stacked bodies (units) may be within the above-mentioned range. However, even in this case, the refractive index layer that constitutes the uppermost layer or the lowermost layer of the optical reflective layer may have a constitution out of the above-mentioned range.

From the viewpoints mentioned above, the number of the refractive index layers (the units of a high refractive index layer and a low refractive index layer) of the optical reflective layer may be 100 layers or less, i.e., 50 units or less, may be 40 layers (20 units) or less, may be 20 layers (10 units) or less.

Since the reflection at the above-mentioned adjacent layer interface depends on a refractive index ratio between the layers, the greater the refractive index ratio is, the more increased the reflectance is. Furthermore, in the case of a single layer film, when the optical path difference between the reflective light and the reflective light on the layer bottom part is set to have a relationship represented by n·d=wavelength/4, the reflective lights can be controlled so as to be enhanced by each other by the phase difference, thereby the reflectance can be increased. In this relationship, n is a refractive index, d is the physical film thickness of the layer, and n·d is the optical film thickness. By utilizing this optical path difference, the reflection can be controlled. By utilizing this relationship, the reflectivities of visible light and near infrared ray are controlled by controlling the refractive indexes and the film thicknesses of the respective layers.

That is, the reflectance of a specific wavelength area can be increased by the refractive indexes of the respective layers, the film thicknesses of the respective layers, and the formats of the stacking of the respective layers.

The optical reflective layer used in embodiments of the invention can be used as a ultraviolet reflective film, a visible light reflective film or a near infrared ray reflective film by changing the specific wavelength area where the reflectance is increased. That is, if the specific wavelength area where the reflectance is increased is set to the ultraviolet region, the optical reflective layer becomes a ultraviolet reflective film, if the specific wavelength area is set to the visible light region, the optical reflective layer becomes a visible light reflective film, and if the specific wavelength area is set to the near infrared area, the optical reflective layer becomes a near infrared ray reflective film.

In the case when the optical film having an optical reflective layer used in embodiments of the invention is used in a heat shielding film, the optical film may be a near infrared ray reflective film. A multilayer film may be formed including a polymer film and films having different refractive indexes each other which are stacked on the polymer film, and to design the optical film thickness and the units so as to have a transmittance of the visible light region indicated by JIS R3106-1998 of 50% or more and have an area with a reflectance of more than 40% at an area with a wavelength of from 900 to 1,400 nm.

<Refractive Index Layer: High Refractive Index Layer and Low Refractive Index Layer>

### [High Refractive Index Layer]

The high refractive index layer contains a first water-soluble binder resin and first metal oxide particles, and where necessary, may contain a curing agent, other binder resin, a surfactant, and various additives and the like.

The refractive index of the high refractive index layer in embodiments of the invention may be from 1.80 to 2.50, may be from 1.90 to 2.20.

(First Water-Soluble Binder Resin)

The first water-soluble binder resin in embodiments of the invention refers to a binder resin such that when the water-soluble binder resin is dissolved in water at a concentration of 0.5% by mass at a temperature at which the binder resin is most dissolved, the mass of an insoluble matter that is separated by filtration by means of a G2 glass filter (maximum fine pore: 40 to 50 μm) is within 50% by mass of the added water-soluble binder resin.

The weight average molecular weight of the first water-soluble binder resin may be within the range of from 1,000 to 200,000. Furthermore, the range within from 3,000 to 40,000 may be used.

The weight average molecular weight as referred to in embodiments of the invention can be measured by a known method, for example, can be measured by means of static light scattering, gel permeation chromatography (GPC), time of flight mass spectrometry (TOF-MASS) or the like. In embodiments of the invention, the measurement is conducted by gel permeation chromatography, which is a general known method.

The content of the first water-soluble binder resin in the high refractive index layer may be within the range of from 5 to 50% by mass, may be within the range of from 10 to 40% by mass with respect to 100% by mass of the solid content of the high refractive index layer.

The first water-soluble binder resin applied to the high refractive index layer may be a polyvinyl alcohol. Furthermore, the water-soluble binder resin that is present in the low refractive index layer mentioned below may also be a polyvinyl alcohol. Accordingly, the polyvinyl alcohols to be incorporated in the high refractive index layer and the low refractive index layer will be explained below in combination.

<Polyvinyl Alcohol>

In embodiments of the invention, the high refractive index layer and the low refractive index layer may contain two or more kinds of polyvinyl alcohols having different saponification degrees. Here, for the sake of discrimination, the polyvinyl alcohol used as a water-soluble binder resin in the high refractive index layer is referred to as polyvinyl alcohol (A), and the polyvinyl alcohol used as a water-soluble binder resin in the low refractive index layer is referred to as polyvinyl alcohol (B). Incidentally, in the case when each refractive index layer contains a plurality of polyvinyl alcohols having different saponification degrees and polymerization degrees, the polyvinyl alcohol having the highest content is referred to as polyvinyl alcohol (A) in the high refractive index layer, and polyvinyl alcohol (B) in the low refractive index layer, respectively, in each refractive index layer.

The “saponification degree” as referred to in embodiments of the invention means the ratio of the hydroxy groups with respect to the total number of the acetyloxy groups (derived from vinyl acetate as a raw material) and the hydroxy groups in the polyvinyl alcohol.

Furthermore, when “the polyvinyl alcohol having the highest content in the refractive index layer” herein is referred to that the polymerization degree is calculated with deeming that the polyvinyl alcohols that are different in saponification degrees by within 3 mol % are an identical polyvinyl alcohol. However, the low-polymerization degree polyvinyl alcohols with polymerization degrees of 1,000 or less are deemed as different polyvinyl alcohols (if polyvinyl alcohols that are different in saponification degrees by within 3 mol % are present, the polyvinyl alcohols are not deemed as identical). Specifically, in the case when polyvinyl alcohols having a saponification degree of 90 mol %, a saponification degree of 91 mol % and a saponification degree of 93 mol % are contained in an identical layer by 10% by mass, 40% by mass and 50% by mass, respectively, these three polyvinyl alcohols are deemed as an identical polyvinyl alcohol, and a mixture of these three polyvinyl alcohols is deemed as polyvinyl alcohol (A) or (B). Furthermore, in the above-mentioned “polyvinyl alcohols that are different in saponification degrees by within 3 mol %”, it is sufficient that, in the case when either of the polyvinyl alcohols is focused, the saponification degree of the polyvinyl alcohol is within 3 mol %, and for example, in the case when polyvinyl alcohols of 90 mol %, 91 mol %, 92 mol % and 94 mol % are contained, in the case when the polyvinyl alcohol of 91 mol % is focused, the difference in the saponification degrees in either of the polyvinyl alcohols is within 3 mol %, and thus the polyvinyl alcohols are deemed as identical.

In the case when a polyvinyl alcohol having a saponification degree that differs by 3 mol % or more is contained in the identical layer, the polyvinyl alcohol is deemed as a mixture of different polyvinyl alcohols, and thus the polymerization degrees and the saponification degrees are calculated for the respective polyvinyl alcohols. For example, in the case when PVA203: 5% by mass, PVA117: 25% by mass, PVA217: 10% by mass, PVA220: 10% by mass, PVA224: 10% by mass, PVA235: 20% by mass and PVA245: 20% by mass are contained, the PVA (polyvinyl alcohol) with the largest content is a mixture of PVA217 to 245 (since the differences in the saponification degrees in PVA217 to 245 are within 3 mol %, these are an identical polyvinyl alcohol), and the mixture is deemed as polyvinyl alcohol (A) or (B). Therefore, in the mixture of PVA217 to 245 (polyvinyl alcohol (A) or (B)), the polymerization degree is (1,700×0.1+2,000×0.1+2,400×0.1+3,500×0.2+4,500×0.7)/0.7=3,200, and the saponification degree is 88 mol %.

The difference in the absolute values of the saponification degrees of polyvinyl alcohol (A) and polyvinyl alcohol (B) may be 3 mol % or more, may be 5 mol % or more. The interlayer mixed state between the high refractive index layer and the low refractive index layer may reach a level. Furthermore, a greater difference between the saponification degrees of polyvinyl alcohol (A) and polyvinyl alcohol (B) may occur, but the difference may be 20 mol % or less in view of the solubility of the polyvinyl alcohol in water.

Furthermore, the saponification degrees of polyvinyl alcohol (A) and polyvinyl alcohol (B) are each 75 mol % or more from the viewpoint of solubility in water. Furthermore, one of polyvinyl alcohol (A) and polyvinyl alcohol (B) may have a saponification degree of 90 mol % or more and the other may have a saponification degree of 90 mol % or less so as to put the interlayer mixed state between the high refractive index layer and the low refractive index layer to a level. One of polyvinyl alcohol (A) and polyvinyl alcohol (B) may have a saponification degree of 95 mol % or more and the other may have a saponification degree of 90 mol % or less. Incidentally, although the upper limit of the saponification degrees of the polyvinyl alcohols is not specifically limited, it is generally lower than 100 mol %, and is about 99.9 mol % or less.

Furthermore, as the two kinds of polyvinyl alcohols having different saponification degrees, those having polymerization degrees of 1,000 or more may be used, and those having polymerization degrees within the range of from 1,500 to 5,000 are may be used, and those having polymerization degrees within the range of from 2,000 to 5000 are may be used. If the polymerization degrees of the polyvinyl alcohols are 1,000 or more, no cracking occurs on an applied film, and if the polymerization degrees are 5,000 or less, the application liquid is stabilized. Incidentally, in the present specification, that “the application liquid is stabilized” means that the application liquid is stabilized over time. If the polymerization degree(s) of at least one of polyvinyl alcohol (A) and polyvinyl alcohol (B) is/are within the range of from 2,000 to 5,000, the cracking of the coating is decreased, and the reflectance at the specific wavelength is improved. If both of polyvinyl alcohol (A) and polyvinyl alcohol (B) are within the range of from 2,000 to 5,000, the above-mentioned effect can be exerted more significantly.

“Polymerization degree P” as referred to in this specification means a viscosity average polymerization degree, and is measured in accordance with JIS K6726 (1994), and is obtained using the formula (1) below from a limiting viscosity [η] (dl/g), which is obtained by completely re-saponifying PVA, purifying the resultant, and measuring the limiting viscosity in water of 30° C.

P=([η]×10³/8.29)^{(1/0.62)} Formula (1)

The polyvinyl alcohol (B) contained in the low refractive index layer may have a saponification degree in the range of from 75 to 90 mol %, and a polymerization degree in the range of from 2,000 to 5,000. If the polyvinyl alcohol having such properties may be incorporated in the low refractive index layer, the mixing at the interface may be further suppressed. The reason therefor is considered that the cracking of the coating is small and the setting property is improved.

As polyvinyl alcohols (A) and (B) used in embodiments of the invention, synthesis products may be used, or commercially available products may be used. Examples of the commercially available products used as polyvinyl alcohol (A) and (B) include PVA-102, PVA-103, PVA-105, PVA-110, PVA-117, PVA-120, PVA-124, PVA-203, PVA-205, PVA-210, PVA-217, PVA-220, PVA-224 and PVA-235 (these are manufactured by Kuraray Co., Ltd.), JC-25, JC-33, JF-03, JF-04, JF-05, JP-03, JP-04J, P-05 and JP-45 (these are manufactured by Japan VAM & POVAL Co., Ltd.), and the like.

The first water-soluble binder resin in embodiments of the invention may also contain a modified polyvinyl alcohol in which a part has been modified, beside a general polyvinyl alcohol that is obtained by hydrolyzing polyvinyl acetate, as long as the effect of embodiments of the invention is deteriorated. If such modified polyvinyl alcohol is contained, the tight adhesiveness, water resistance and flexibility of the film may be improved. Examples of such modified polyvinyl alcohol include cation-modified polyvinyl alcohols, anion-modified polyvinyl alcohols, nonion-modified polyvinyl alcohols, and vinyl alcohol-based polymers.

The cation-modified polyvinyl alcohols are, for example, polyvinyl alcohols each having the primary to tertiary amino groups and a quaternary ammonium group in the main chain or side chains of the above-mentioned polyvinyl alcohols as described in JP 61-10483 A, and these can be obtained by saponifying a copolymer of an ethylenically unsaturated monomer having a cationic group and vinyl acetate.

Examples of the ethylenically unsaturated monomer having a cationic group include trimethyl-(2-acrylamide-2,2-dimethylethyl)ammonium chloride, trimethyl-(3-acrylamide-3,3-dimethylpropyl)ammonium chloride, N-vinylimidazole, N-vinyl-2-methylimidazole, N-(3-dimethylaminopropyl)methacrylamide, hydroxylethyltrimethylammonium chloride, trimethyl-(2-methacrylamidepropyl)ammonium chloride, N-(1,1-dimethyl-3-dimethylaminopropyl)acrylamide and the like. The ratio of the cation-modified group-containing monomer in the cation-modified polyvinyl alcohol is from 0.1 to 10 mol %, or may be from 0.2 to 5 mol % with respect to the vinyl acetate.

Examples of the anion-modified polyvinyl alcohols include polyvinyl alcohols having an anionic group as described in JP 1-206088 A, copolymers of a vinyl alcohol and a vinyl compound having a water-soluble group as described in JP 61-237681 A and JP 63-307979 A, and modified polyvinyl alcohols having a water-soluble group as described in JP 7-285265 A.

Furthermore, examples of the nonionic modified polyvinyl alcohols include polyvinyl alcohol derivatives in which polyalkylene oxide groups have been added to a part of the vinyl alcohols as described in JP 7-9758 A, the block copolymer of a vinyl compound having a hydrophobic group and a vinyl alcohol described in JP 8-25795 A, silanol-modified polyvinyl alcohols having silanol groups, reactive group-modified polyvinyl alcohols having reactive groups such as an acetacetyl group, a carbonyl group and a carboxy group, and the like.

Furthermore, examples of the vinyl alcohol-based polymers include Exeval (registered trademark, manufactured by Kuraray Co., Ltd.), Nichigo G polymer (registered trademark, manufactured by Nippon Synthetic Chemical Industry Co., Ltd.) and the like.

Two or more kinds of modified polyvinyl alcohols can be used in combination depending on the difference in the polymerization degrees, modifications and the like.

The content of the modified polyvinyl alcohol(s) is not specifically limited, and may be within the range of from 1 to 30% by mass with respect to the total mass (solid contents) of the respective refractive indexes. The above-mentioned effect is further exerted within such range.

In embodiments of the invention, two kinds of polyvinyl alcohols having different saponification degrees may be respectively used between the layers having different refractive indexes.

For example, in the case when polyvinyl alcohol (A) having a low saponification degree is used in the high refractive index layer and polyvinyl alcohol (B) having a high saponification degree is used in the low refractive index layer, the polyvinyl alcohol (A) in the high refractive index layer is contained in the range of 40% by mass or more and 100% by mass or less, may be in the range of 60% by mass or more and 95% by mass or less with respect to the total mass of all of the polyvinyl alcohols in the layer, and the polyvinyl alcohol (B) in the low refractive index layer is contained in the range of 40% by mass or more and 100% by mass or less, may be in the range of 60% by mass or more and 95% by mass or less with respect to the total mass of all of the polyvinyl alcohols in the layer. Furthermore, in the case when polyvinyl alcohol (A) having a high saponification degree is used in the high refractive index layer and polyvinyl alcohol (B) having a low saponification degree is used in the low refractive index layer, polyvinyl alcohol (A) in the high refractive index layer is contained in the range of 40% by mass or more and 100% by mass or less, may be in the range of 60% by mass or more and 95% by mass or less with respect to the total mass of all of the polyvinyl alcohols in the layer, and polyvinyl alcohol (B) in the low refractive index layer is contained in the range of 40% by mass or more and 100% by mass or less, may be in the range of 60% by mass or more and 95 mass or less with respect to the total mass of all of the polyvinyl alcohols in the layer. When the content is 40% by mass or more, the mixing between the layers is suppressed, and thus an effect that the disturbance of the interface is decreased appears significantly. On the other hand, when the content is 100% by mass or less, the stability of the application liquid is improved.

(Other Binder Resin)

In embodiments of the invention, as the first water-soluble binder resin other than polyvinyl alcohols in the high refractive index layer, any substance can be used without limitation as long as the high refractive index layer containing the first metal oxide particles can form a coating. Furthermore, also in the low refractive index layer mentioned below, as the second water-soluble binder resin other than polyvinyl alcohol (B), in a similar manner to that mentioned above, any substance can be used without limitation as long as the low refractive index layer containing the second metal oxide particles can form a coating. However, considering the environment and the flexibility of the coating, water-soluble polymers (specifically gelatin, thickening polysaccharides, polymers having reactive functional groups) may be used. These water-soluble polymers may be used singly or by mixing two or more kinds.

In the high refractive index layer, the content of the other binder resin that is used in combination with the polyvinyl alcohol that may be used as the resin water-soluble binder resin can be used within the range of from 5 to 50% by mass with respect to 100% by mass of the solid content of the high refractive index layer.

In embodiments of the invention, the binder resin may be constituted by a water-soluble polymer since it is not necessary to use an organic solvent, and this may improve environmental conservation. That is, in embodiments of the invention, as long as the effect thereof is not deteriorated, a water-soluble polymer other than polyvinyl alcohols and modified polyvinyl alcohols may also be used as the binder resin in addition to the above-mentioned polyvinyl alcohol and modified polyvinyl alcohol. The above-mentioned water-soluble polymer refers to a water-soluble polymer such that when the water-soluble binder resin is dissolved in water at a concentration of 0.5% by mass at a temperature at which the binder resin is most dissolved, the mass of an insoluble matter that is separated by filtration by means of a G2 glass filter (maximum fine pore: 40 to 50 μm) is within 50% by mass of the added water-soluble binder resin. Among such water-soluble polymers, gelatin, celluloses, thickening polysaccharides, or polymers having reactive functional groups may be used. These water-soluble polymers may be used singly, or may be used by mixing two or more kinds.

(First Metal Oxide Particles)

In embodiments of the invention, as the first metal oxide particles that can be applied to the high refractive index layer, metal oxide particles having a refractive index of 2.0 or more and 3.0 or less may be used. Furthermore, specific examples include titanium oxide, zirconium oxide, zinc oxide, synthetic amorphous silica, colloidal silica, alumina, colloidal alumina, lead titanate, red lead, yellow lead, zinc yellow, chromium oxide, ferric oxide, iron black, copper oxide, magnesium oxide, magnesium hydroxide, strontium titanate, yttrium oxide, niobium oxide, europium oxide, lanthanum oxide, zircon, tin oxide and the like. Alternatively, composite oxide particles constituted by a plurality of metals, core-shell particles in which the metal constitution changes in a core-shell like form or the like can also be used.

In order to form a high refractive index layer that is transparent and has a higher refractive index, oxide microparticles of a metal having a high refractive index such as titanium or zirconium, i.e., titanium oxide microparticles and/or zirconia oxide microparticles may be incorporated in the high refractive index layer. Among these, in view of the stability of the application liquid for forming a high refractive index layer, titanium oxide may be used. Furthermore, in titanium oxide, a rutile type (tetragonal shape) may be used rather than an anatase type, since the rutile type has low catalyst activity, and thus the weather resistances of the high refractive index layer and the adjacent layer are increased, and the refractive index is also increased.

Furthermore, in the case when core-shell particles are used as the first metal oxide particles in the high refractive index layer, core-shell particles in which titanium oxide particles are coated with a silicon-containing hydrate oxide may be used due to their effect that the interlayer mixing between the high refractive index layer and the adjacent layer is suppressed by the interaction of the silicon-containing hydrate oxide of the shell layer and the first water-soluble binder resin.

The content of the first metal oxide particles in embodiments of the invention may be within the range of from 15 to 80% by mass with respect to 100% by mass of the solid content of the high refractive index layer from the viewpoint that a refractive index difference from the low refractive index layer is imparted. Furthermore, the content is may be within the range of from 20 to 77% by mass, may be within the range of from 30 to 75% by mass. Incidentally, the content in the case when metal oxide particles other than the core-shell particles are contained in the high refractive index layer is not specifically limited as long as it is within the range at which the effect of embodiments of the invention can be exerted.

In embodiments of the invention, the volume average particle size of the first metal oxide particles applied to the high refractive index layer may be 30 nm or less, may be within the range of from 1 to 30 nm, may be within the range of from 5 to 15 nm. If the volume average particle size is within the range of from 1 to 30 nm, the haze is small and the transmission of visible light is excellent.

Incidentally, the volume average particle size of the first metal oxide particles in embodiments of the invention is an average particle size that is obtained by a method of observing the particles themselves by a laser diffraction scatter process, a dynamic light scattering process, or by using an electron microscope, or a method of observing the images of the particles appearing on the cross-sectional surface or surface of the refractive index layer by an electron microscope, wherein the average particle size is an average particle size weight by a volume represented by a volume average particle size mv={Σ(vi·di)}/{Σ(vi)}, in the case when the particle sizes of 1,000 optional particles are measured, and the volume of one particle is deemed as vi in a population of a particulate metal oxide in which particles respectively having particle sizes of d1, d2 . . . di . . . dk are respectively present by n1, n2 . . . ni . . . nk particles.

Furthermore, the first metal oxide particles in embodiments of the invention are monodispersed. The monodispersed herein refers to that a monodispersion degree obtained by the following formula (2) is 40% or less. The monodispersion degree is may be 30% or less, or may be within the range of from 0.1 to 20%.

Monodispersion degree=(standard deviation of particle size)/(average value of particle size)×100(%) Formula (2)

### <Core-Shell Particles>

As the first metal oxide particles applied to the high refractive index layer in embodiments of the invention, “titanium oxide particles surface-treated with a silicon-containing hydrate oxide” may be used, and titanium oxide particles of such form are sometimes referred to as “core-shell particles” or “Si-coated TiO₂”.

The core-shell particles used in embodiments of the invention each have a structure in which a titanium oxide particle is coated with a silicon-containing hydrate oxide, a structure in which the surface of each of titanium oxide particles as core parts having an average particle size within the range of from 1 to 30 nm, may be an average particle size within the range of from 4 to 30 nm is coated with a shell formed of a silicon-containing hydrate oxide so that the coating amount of the silicon-containing hydrate oxide is within the range of from 3 to 30% by mass in terms of SiO₂ with respect to the titanium oxide as a core.

That is, in embodiments of the invention, by incorporating the core-shell particles, an effect that the interlayer mixing of the high refractive index layer and the low refractive index layer is suppressed by the interaction between the silicon-containing hydrate oxide in the shell layer and the first water-soluble binder resin, and an effect that deterioration and choking of a binder by the photocatalytic activity of titanium oxide in the case when the titanium oxide is used as the core, are exerted.

In one or more embodiments of the invention, the core-shell particles are such that the coating amount of the silicon-containing hydrate oxide may be within the range of from 3 to 30% by mass, may be within the range of from 3 to 10% by mass, may be within the range of from 3 to 8% by mass in terms of SiO₂ with respect to the titanium oxide as the core. If the coating amount is 30% by mass or less, increasing of the refractive index of the high refractive index layer can be achieved. Furthermore, if the coating amount is 3% by mass or more, the particles in the core-shell particles can be stably formed.

Furthermore, in one or more embodiments of the invention, the average particle size of the core-shell particles may be within the range of from 1 to 30 nm, may be within the range of from 5 to 20 nm, may be within the range of from 5 to 15 nm. If the average particle size of the core-shell particles is within the range of from 1 to 30 nm, optical properties such as near infrared ray reflectance, transparency and haze can further be improved.

Incidentally, the average particle size as referred to in one or more embodiments of the invention means a primary average particle size, and can be measured from an electron microscopic photograph by a transmission electron microscope (TEM) or the like. The measurement may also be conducted by a particle size distribution meter or the like utilizing a dynamic light scattering process, a static light scattering process or the like.

In the case when the average particle size of the primary particles is obtained from an electron microscope, the average particle size is obtained by observing the particles themselves or particles appearing on the cross-sectional surface and surface of the refractive index layer under an electron microscope, measuring the particle sizes of optional 1,000 particles, and obtaining an average particle size as a simple average value (number average) of the particle sizes. The particle size of each particle is represented by a diameter when a circle that is equal to the projected surface area of the particle is supposed.

A known method can be adopted as the method for producing the core-shell particles that can be applied to embodiments of the invention, and for example, JP 10-158015 A, JP 2000-053421 A, JP 2000-063119 A, JP 2000-204301 A, JP 4550753 B and the like can be referred to.

In embodiments of the invention, the silicon-containing hydrate oxide to be applied to the core-shell particles may be either of a hydrate of an inorganic silicon compound, and a hydrolysate or condensation of an organic silicon compound, and a compound having a silanol group may be used.

The core-shell particles used in one or more embodiments of the invention may be those obtained by coating the whole surfaces of titanium oxide particles as cores with a silicon-containing hydrate oxide, or those obtained by coating a part of the surfaces of titanium oxide particles as cores with a silicon-containing hydrate oxide.

(Curing Agent)

In one or more embodiments of the invention, a curing agent can be used so as to cure the first water-soluble binder resin applied to the high refractive index layer. As specific examples of the curing agent, for example, in the case when a polyvinyl alcohol is used as the first water-soluble binder resin, boric acid and salts thereof may be used as the curing agent. Besides the boric acid and salts thereof, known curing agents can be used, and examples include epoxy-based curing agents (diglycidyl ethyl ether, ethylene glycol diglycidyl ether, 1,4-butanediol diglycidyl ether, 1,6-diglycidylcyclohexane, N,N-diglycidyl-4-glycidyloxyaniline, sorbitol polyglycidyl ether, glycerol polyglycidyl ether and the like), aldehyde-based curing agents (formaldehyde, glyoxal and the like), active halogen-based curing agents (2,4-dichloro-4-hydroxy-1,3,5-s-triazine and the like), active vinyl-based compounds (1,3,5-trisacryloyl-hexahydro-s-triazine, bisvinylsulfonylmethyl ether and the like), aluminum alum and the like.

The content of the curing agent in the high refractive index layer may be from 1 to 10% by mass, may be from 2 to 6% by mass with respect to 100% by mass of the solid content of the high refractive index layer.

Specifically, the total used amount of the above-mentioned curing agent in the case when the polyvinyl alcohol is used as the first water-soluble binder resin may be from 1 to 600 mg per 1 g of the polyvinyl alcohol, may be from 100 to 600 mg per 1 g of the polyvinyl alcohol.

[Low Refractive Index Layer]

The low refractive index layer in one or more embodiments of the invention contains a second water-soluble binder resin and second metal oxide particles, and may further contain a curing agent, a surface coating component, a particle surface protective agent, a binder resin, a surfactant, various additives and the like.

The low refractive index layer in one or more embodiments of the invention has a refractive index of within the range of from 1.10 to 1.60, may be from 1.30 to 1.50.

(Second Water-Soluble Binder Resin)

As the second water-soluble binder resin to be applied to the low refractive index layer in one or more embodiments of the invention, a polyvinyl alcohol may be used. Furthermore, polyvinyl alcohol (B), which has a saponification degree that is different from the saponification degree of polyvinyl alcohol (A) that is present in the above-mentioned high refractive index layer may be used in the low refractive index layer in one or more embodiments of the invention. Incidentally, the explanations on the weight average molecular weight and the like of the second water-soluble binder resin, and polyvinyl alcohol (A) and polyvinyl alcohol (B) are explained for the water-soluble binder resin of the above-mentioned high refractive index layer, and thus the explanations thereof are omitted here.

The content of the second water-soluble binder resin in the low refractive index layer may be within the range of from 20 to 99.9% by mass, may be within the range of from 25 to 80% by mass, with respect to 100% by mass of the solid content of the low refractive index layer.

In the low refractive index layer, the content of the other binder resin that is used in combination with the polyvinyl alcohol that may be used as the second water-soluble binder resin can be used within the range of from 0 to 10% by mass with respect to 100% by mass of the solid content of the low refractive index layer.

(Second Metal Oxide Particles)

As the second metal oxide particles applied to the low refractive index layer in one or more embodiments of the invention, silica (silicon dioxide) may be used, and specific examples include synthetic amorphous silicas, colloidal silicas and the like. Among these, an acidic colloidal silica sol may be used, a colloidal silica sol dispersed in an organic solvent may be used. Furthermore, in order to further decrease the refractive index, hollow microparticles having empty pores inside of the particles can be used as the second metal oxide particles applied to the low refractive index layer, and hollow microparticles of silica (silicon dioxide) may be used.

The second metal oxide particles (preferably silicon dioxide) applied to the low refractive index layer may have an average particle size of within the range of from 3 to 100 nm. The average particle size of the primary particles of the silicon dioxide dispersed in the state of primary particles (a particle size in a state of a dispersion liquid before application) may be within the range of from 3 to 50 nm, may be within the range of from 3 to 40 nm, may be from 3 to 20 nm, or may be within the range of from 4 to 10 nm. Furthermore, the average particle size of the secondary particles may be 30 nm or less from the viewpoints of small haze and excellent visible light transmission.

The average particle size of the metal oxide particles applied to the low refractive index layer is obtained by observing the particles themselves or particles appearing on the cross-sectional surface and surface of the refractive index layer under an electron microscope, measuring the particle sizes of optional 1,000 particles, and obtaining an average particle size as a simple average value (number average) of the particle sizes. The particle size of each particle is represented by a diameter when a circle that is equal to the projected surface area of the particle is supposed.

The colloidal silica used in one or more embodiments of the invention is obtained by heat-aging a silica sol that is obtained by double decomposition of sodium silicate by an acid or the like or passing sodium silicate through an ion exchange resin layer, and is described in, for example, JP 57-14091 A, JP 60-219083 A, JP 60-219084 A, JP 61-20792 A, JP 61-188183 A, JP 63-17807 A, JP 4-93284 A, JP 5-278324 A, JP 6-92011A, JP 6-183134 A, JP 6-297830 A, JP 7-81214 A, JP 7-101142 A, JP 7-179029 A, JP 7-137431 A and WO 94/26530 A and the like.

As such colloidal silica, a synthetic product may be used, or a commercially available product may be used. The colloidal silica may be one whose surface has undergone cation modification, or one that has been treated with Al, Ca, Mg or Ba or the like.

As the second metal oxide particles applied to the low refractive index layer, hollow particles can also be used. In the case when the hollow particles are used, the average particle empty pore diameter may be within the range of from 3 to 70 nm, may be within the range of from 5 to 50 nm, may be within the range of from 5 to 45 nm. Incidentally, the average particle empty pore diameter of the hollow particles is an average value of the inner diameters of the hollow particles. In one or more embodiments of the invention, if the average particle empty pore diameter of the hollow particles is within the above-mentioned range, the refractive index of the low refractive index layer is sufficiently decreased. The average particle empty pore diameter can be obtained by randomly observing 50 or more empty pore diameters that can be observed as circular shapes, oval shapes of substantially circular or oval shapes by an observation under an electron microscope, obtaining the empty pore diameters of the respective particles, and obtaining a number average value of the empty pore diameters. Incidentally, the average particle empty pore diameter means the shortest distance among the distances each interposed by two parallel lines at the outer edge of the empty pore diameter that can be observed as a circular shape, an oval shape or a substantially circular or oval shape.

The content of the second metal oxide particles in the low refractive index layer may be from 0.1 to 70% by mass, may be from 30 to 70% by mass, may be from 45 to 65% by mass with respect to 100% by mass of the solid content of the low refractive index layer.

(Curing Agent)

The low refractive index layer in one or more embodiments of the invention can further contain a curing agent as in the above-mentioned high refractive index layer. The curing agent is not specifically limited as long as it causes a curing reaction with the second water-soluble binder resin contained in the low refractive index layer. Specifically, as the curing agent in the case when a polyvinyl alcohol is used as the second water-soluble binder resin applied to the low refractive index may be boric acid and salts thereof and/or borax. Furthermore, besides boric acid and salts thereof, known curing agents can be used.

The content of the curing agent in the low refractive index layer may be within the range of from 1 to 10% by mass, may be within the range of from 2 to 6% by mass, with respect to 100% by mass of the solid content of the low refractive index layer.

[Other Additives of Respective Refractive Index Layers]

Where necessary, various additives can be used in the high refractive index layer and the low refractive index layer in one or more embodiments of the invention. Furthermore, the content of the additive(s) in the high refractive index layer may be 0 to 20% by mass with respect to 100% by mass of the solid content of the high refractive index layer. Examples of such additives can include the surfactants, amino acids, emulsion resins and lithium compounds described in paragraphs [0140] to [0154] of JP 2012-139948 A, and the other additives described in paragraph [0155] of the same publication.

[Method for Forming Group of Optical Reflective Layers]

The method for forming the group of the optical reflective layers used in one or more embodiments of the invention may be formed by applying a wet application system, and a production method including a step of wet application of an application liquid for a high refractive index layer containing a first water-soluble binder resin and first metal oxide particles and an application liquid for a low refractive index layer containing a second water-soluble binder resin and second metal oxide particles on the supporting body in one or more embodiments of the invention may be used.

The wet application method is not specifically limited, and examples include a roll coating process, a rod bar coating process, an air knife coating process, a spray coating process, a slide-type curtain application process, or the slide hopper application process and the extrusion coat process described in U.S. Pat. No. 2,761,419, U.S. Pat. No. 2,761,791 and the like, and the like. Furthermore, the system for the multi-layer coating of a plurality of layers may be either a successive multi-layer coating system or a simultaneous multi-layer coating system.

Simultaneous multi-layer coating by a slide hopper application process may be a production method (application method) used in one or more embodiments of the invention, will be explained below in detail.

(Solvent)

The solvent that can be applied for preparing the application liquid for the high refractive index layer and the application liquid for the low refractive index layer are not specifically limited, and water, organic solvents, or mixed solvents thereof may be used.

Examples of the organic solvents include alcohols such as methanol, ethanol, 2-propanol and 1-butanol, esters such as ethyl acetate, butyl acetate, propylene glycol monomethyl ether acetate and propylene glycol monoethyl ether acetate, ethers such as diethyl ether, propylene glycol monomethyl ether and ethylene glycol monoethyl ether, amides such as dimethylformamide and N-methylpyrrolidone, ketones such as acetone, methyl ethyl ketone, acetylacetone and cyclohexanone, and the like. These organic solvents may be used singly, or by mixing or two or more kinds.

In view of environments, easiness of operation and the like, solvents for the application liquids may be water, or mixed solvents of water with methanol, ethanol or ethyl acetate.

(Concentration of Application Liquid)

The concentration of the water-soluble binder resin in the application liquid for the high refractive index layer may be within the range of from 1 to 10% by mass. Furthermore, the concentration of the metal oxide particles in the application liquid for the high refractive index layer may be within the range of from 1 to 50% by mass.

The concentration of the water-soluble binder resin in the application liquid for the low refractive index layer may be within the range of from 1 to 10% by mass. Furthermore, the concentration of the metal oxide particles in the application liquid for the low refractive index layer is within the range of from 1 to 50% by mass.

(Method for Preparing Application Liquid)

The method for preparing the application liquid for the high refractive index layer and the application liquid for the low refractive index layer is not specifically limited, and for example, a method including adding, stirring and mixing a water-soluble binder resin, metal oxide particles, and other additives that are added as necessary is exemplified. At this time, the order of addition of the water-soluble binder resin, the metal oxide particles, and the other additives that are used as necessary is also not specifically limited, and the respective components may be sequentially added and mixed under stirring, or may be added at once under stirring and then mixed. Where necessary, the application liquid is further prepared to have a suitable viscosity by using a solvent.

In one or more embodiments of the invention, the high refractive index layer may be formed by using an aqueous application liquid for the high refractive index layer prepared by adding and dispersing core-shell particles therein. At this time, a sol having a pH measured at 25° C. within the range of from 5.0 to 7.5 may be prepared by adding the above-mentioned core-shell particles as, wherein the particles have a negative zeta potential, to the application liquid for the high refractive index layer.

(Viscosity of Application Liquid)

The application liquid for the high refractive index layer and the application liquid for the low refractive index layer when simultaneous multi-layer coating is conducted by a slide hopper application process each have a viscosity at 40 to 45° C. within the range of from 5 to 150 mPa·s, may be within the range of from 10 to 100 mPa·s. Furthermore, the application liquid for the high refractive index layer and the application liquid for the low refractive index layer when simultaneous multi-layer coating is conducted by a slide-type curtain application process each have a viscosity at 40 to 45° C. within the range of from 5 to 1,200 mPa·s, may be within the range of from 25 to 500 mPa·s.

Furthermore, the application liquid for the high refractive index layer and the application liquid for the low refractive index layer each have a viscosity at 15° C. of 100 mPa·s or more, may be within the range of from 100 to 30,000 mPa·s, may be within the range of from 3,000 to 30,000 mPa·s, or may be within the range of from 10,000 to 30,000 mPa·s.

(Application and Drying Methods)

The application and drying methods are not specifically limited, and the application liquid for the high refractive index layer and the application liquid for the low refractive index layer may be warmed to 30° C. or more, apply the application liquid for the high refractive index layer and the application liquid for the low refractive index layer onto a substrate by simultaneous multi-layer coating, once cooling the temperature of the formed coating to from 1 to 15° C. (set), and then dry the coating at 10° C. or more. Drying conditions may be conditions of a wet bulb globe temperature in the range of from 5 to 50° C., and a film surface temperature in the range of from 10 to 50° C. Furthermore, as a system for cooling immediately after application, a horizontal set system may be used in view of improvement of the evenness of the formed coating.

As to the application thicknesses of the application liquid for the high refractive index layer and the application liquid for the low refractive index layer, the application may be conducted so as to give a dry thicknesses as indicated above.

Meanwhile, the above-mentioned set means a step of decreasing the fluidity between the respective layers and in the respective layers by increasing the viscosity of the coating composition by a means such as decreasing the temperature of the coating by blowing the coating with cold air or the like. The applied film is blown with cold air from the surface, and when the surface of the application film is pressurized by a finger, the state that nothing adheres to the finger is defined as a state that the set has been completed.

The time from after the application, blowing with cold air to the completion of the set (set time) may be within 5 minutes, or within 2 minutes. Furthermore, the time of the lower limit is not specifically limited, and a time of 45 seconds or more may be used. If the set time is too short, the mixing of the components in the layer may be insufficient. On the other hand, if the set time is too long, the interlayer diffusion of the metal oxide particles proceeds, and thus the difference in the refractive indexes between the high refractive index layer and the low refractive index layer may be insufficient. Incidentally, if a heat ray shielding film unit between the high refractive index layer and the low refractive index layer is made highly elastic quickly, then it is not necessary to provide the setting step.

The set time can be adjusted by adjusting the concentration of the water-soluble binder resin and the concentration of the metal oxide particles, and by adding other components such as various known gelling agents such as gelatin, pectin, agar, carrageenan and gellan gum.

The temperature of the cold air may be from 0 to 25° C., may be from 5 to 10° C. Furthermore, the time required for the coating to be exposed to the cold air may be from 10 to 120 seconds depending on the transport velocity of the coating.

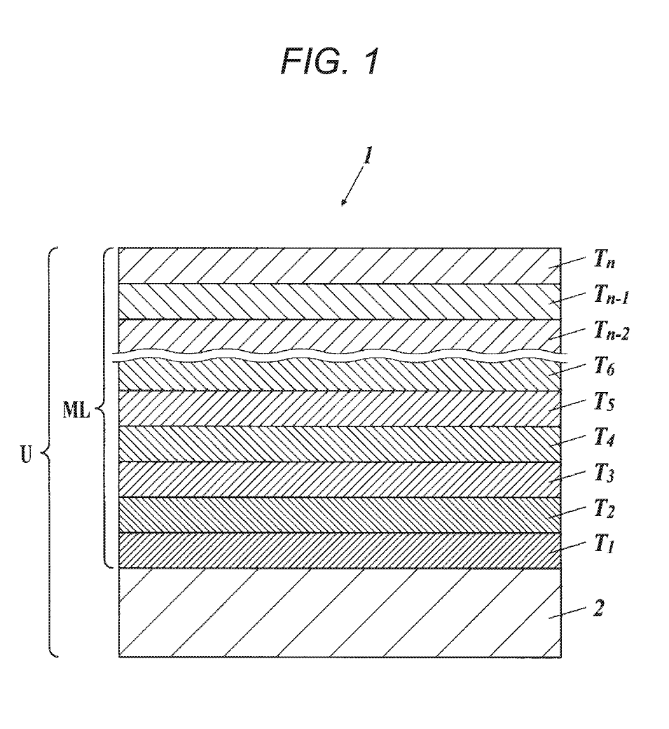

FIG. 1 is a schematic cross-sectional view showing the optical film of one or more embodiments of the invention having reflective layers by a multilayer film, which has a constitution including a supporting body, and a reflective layer unit having a group of reflective layers on one surface of the supporting body.

In FIG. 1, the optical film 1 of one or more embodiments of the invention has a reflective layer unit U. Furthermore, the reflective layer unit U has, on a supporting body material 2, for example, a group of reflective layers ML in which high refractive index reflective layers each containing a first water-soluble binder resin and first metal oxide particles and low refractive index reflective layers each containing a second water-soluble binder resin and second metal oxide particles are alternately stacked. The group of reflective layers ML is constituted by n layers of reflective layers T₁ to Tₙ, and for example, a constitution in which T₁, T₃, T₅, (abbreviated), Tₙ₋₂, Tₙ are each constituted by a low refractive index layer having a refractive index within the range of from 1.10 to 1.60, and T₂, T₄, T₆, (abbreviated), Tₙ₋₁ are each constituted by a high refractive index layer having a refractive index within the range of from 1.80 to 2.50 may be exemplified. The refractive index as referred to in one or more embodiments of the invention is a value measured under an environment of 25° C.

Furthermore, although not illustrated, a hard coat layer may be provided for improving scratch resistance on the outermost layer of the reflective layer unit, and an adhesion layer or a pressure-adhesive layer may be provided for attaching the supporting body to other substrate onto the surface to which the reflective layer unit is not provided of the supporting body.

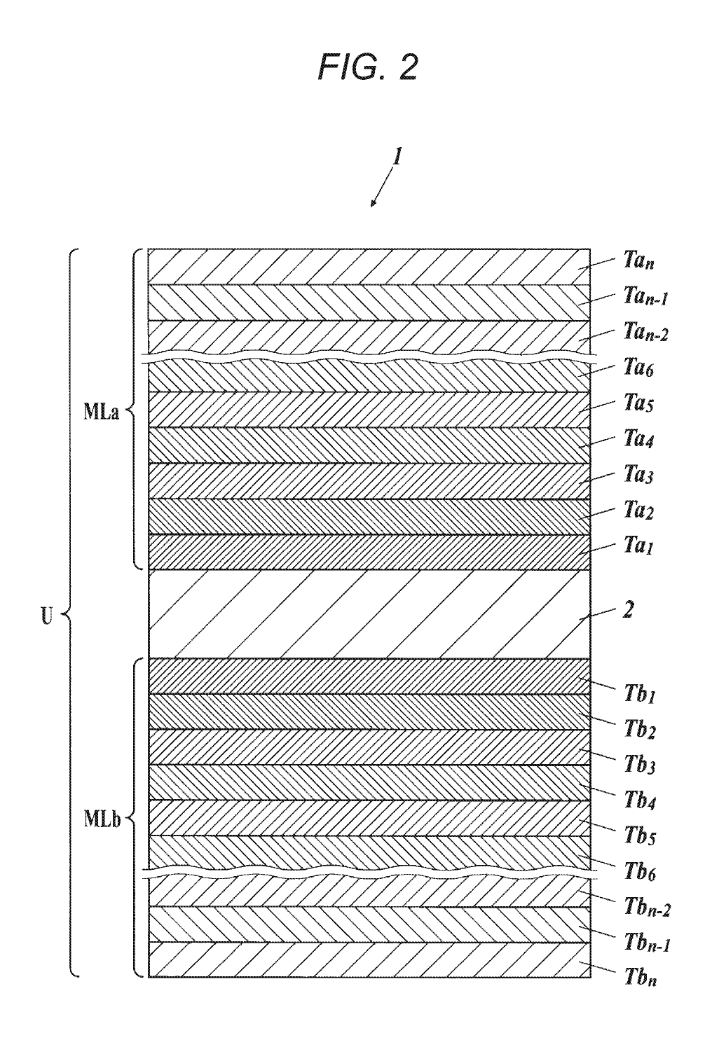

FIG. 2 is a schematic cross-sectional drawing showing another constitution of the optical film of one or more embodiments of the invention having reflective layers by a multilayer film, which is a constitution including a supporting body and reflective layer units each having a group of reflective layers provided to the both surfaces of the supporting body.

(2) Optical Functional Layer that Absorbs Specific Wavelength by Dye or Pigment

As an optical functional layer that absorbs a specific wavelength by a dye or a pigment, an infrared ray absorbing layer is explained as an example.

The materials contained in the infrared ray absorbing layer are not specifically limited, and examples include an ultraviolet curable resin as a binder component, a photopolymerization initiator, an infrared ray absorbing agent and the like. The infrared ray absorbing layer may be such that the included binder component has been cured. The cure herein refers to that curing occurs by the proceeding of a reaction by active energy ray such as ultraviolet ray, heat or the like.

The ultraviolet curable resin is more excellent in hardness and smoothness than other resins are, and is further advantageous in view of the dispersibility of ITO, ATO and thermal conductive metal oxides. Any ultraviolet curable resin can be used without specific limitation as long as it is a substance that forms a transparent layer by curing, and examples include silicone resins, epoxy resins, vinyl ester resins, acrylic resins, allyl ester resins and the like. Acrylic resins may be used in view of hardness, smoothness and transparency.

The above-mentioned acrylic resins may contain reactive silica particles in which photosensitive groups having photopolymerization reactivity have been introduced on the surfaces (hereinafter simply referred to as “reactive silica particles”) as those described in WO 2008/035669 A, in view of hardness, smoothness and transparency. Examples of the photosensitive groups having photopolymerizability can include polymerizable unsaturated groups as represented by a (meth)acryloyloxy group and the like. Furthermore, the ultraviolet curable resin may contain a compound that can react by photopolymerization with the photosensitive groups having photopolymerization reactivity that have been introduced on the surfaces of the reactive silica particles, such as organic compounds having polymerizable unsaturated groups. Furthermore, silica particles in which a polymerizable unsaturated group-modified hydrolysable silane forms a silyloxy group between the silane and silica particles by a hydrolysis reaction of the hydrolysable silyl group, can be used as the reactive silica particles. The reactive silica particles may have an average particle diameter of from 0.001 to 0.1 μm. By presetting the average particle diameter to be within such range, the transparency, smoothness and hardness can be satisfied with good balance.

As the photopolymerization initiator, known photopolymerization initiators can be used, and the photopolymerization initiators can be used singly or in combination of two or more kinds.

As the inorganic infrared ray absorbing agent that can be incorporated in the infrared ray absorbing layer, tin-doped indium oxide (ITO), antimony-dope tin oxide (ATO), zinc antimonate, lanthanum hexaborate (LaB₆), cesium-containing tungsten oxide (Cs0.33WO₃) and the like may be used in view of visible ray transmittance, infrared ray absorbability, dispersion adequacy in the resin, and the like.

The content of the above-mentioned inorganic infrared ray absorbing agent in the infrared ray absorbing layer may be from 1 to 80% by mass, may be from 5 to 50% by mass with respect to the total mass of the infrared ray absorbing layer. If the content is 1% or more, a sufficient infrared ray absorbing effect appears, whereas if the content is 80% or less, a sufficient amount of visible ray can be transmitted.

Furthermore, examples of the organic infrared ray absorbing materials include polymethine-based, phthalocyanine-based, naphthalocyanine-based, metal complex-based, aminium-based, immonium-based, diimmonium-based, anthraquinone-based, dithiol metal complex-based, naphthoquinone-based, indolephenol-based, azo-based and triallylmethane-based compounds, and the like. Specifically, metal complex-based compounds, aminium-based compounds (aminium derivatives), phthalocyanine-based compounds (phthalocyanine derivatives), naphthalocyanine-based compounds (naphthalocyanine derivatives), diimmonium-based compounds (diimmonium derivatives), squalium-based compounds (squalium derivatives) and the like may be used.

The thickness of the infrared ray absorbing layer may be in the range of from 0.1 to 50 μm, may be in the range of from 1 to 20 μm. If the thickness is 0.1 μm or more, the infrared ray absorbability tends to be improved, whereas when the thickness is 50 μm or less, the crack resistance of the coating is improved.

The method for forming the infrared ray absorbing layer is not specifically limited, and examples include a method for forming by preparing an application liquid for the infrared ray absorbing layer containing the above-mentioned respective components, applying the application liquid by using a wire bar or the like, and drying the application liquid.

(3) Optical Functional Layer that Reflects Infrared Ray by Providing Metal Thin Film

A method for reflecting infrared ray light may be adopted by providing a metal thin film to the optical reflective layer used in one or more embodiments of the invention.

The metal thin film may be formed of a metal layer, or a metal layer and a metal oxide layer and/or a metal nitride layer. An infrared ray reflective function is expressed by the metal layer containing a metal, and the visible light transmittance can be increased by using the metal oxide layer and/or the metal nitride layer, although the use is not essential.

The metal layer used in one or more embodiments of the invention may contain silver, which is excellent in infrared ray reflective conductance, as a major component, and contain at least gold and/or palladium by 2 to 5% by mass in total of gold atoms and palladium atoms. These metal oxides (or metal nitrides) can be formed in combination with the metal layer by using a known technology such as a vacuum deposition process, a sputtering process, an ion plating process or the like.

(4) Easy Adhesion Layer

An easy adhesion layer may be provided to the supporting body in one or more embodiments of the invention before providing the optical functional layer in one or more embodiments of the invention.

The resin for forming the easy adhesion layer is not specifically limited as long as it has high transparency and durability. For example, acrylic-based resins, urethane-based resins, fluorine-based resins, silicon-based resins and the like can be used singly or as a mixture. These easy adhesion layers can be formed by applying a solution of a resin or a resin composition by a known technique such as a gravure coating process, a reverse roll coating process, a roll coating process, a dip coating process or the like, and curing the solution by drying, and where necessary, by irradiating with ultraviolet ray, electron beam or the like. The thickness of the easy adhesion layer may be from 0.5 to 5 μm, or may be from 1 to 3 μm.

(5) Other Functional Layers

In the optical film of one or more embodiments of the invention, for the purpose of addition of further functions, an electroconductive layer, an antistatic layer, a gas barrier layer, an antifouling layer, an odor eliminating layer, a dripping layer, an easily slidable layer, a hard coat layer, an antiwearing layer, an electromicrowave shielding layer, an ultraviolet absorbing layer, a printing layer, a fluorescent layer, a hologram layer, a peeling layer, an adhesion layer and the like may be provided onto the supporting body.

### EXAMPLES

Embodiments will be specifically explained below with referring to Examples, but the present invention is not limited to these Examples. In Examples, the notation “part(s)” or “%” is used, and the notation represents “part(s) by mass” or “% by mass” unless otherwise specifically mentioned.

<Preparation of Supporting Body 1 (TAC; Comparative Example)>

The following components were mixed by means of a dissolver for 50 minutes under stirring, and dispersed by means of a Manton-Gaulin to prepare a microparticle-dispersion liquid.

(Microparticle-Dispersion Liquid)

Microparticles (Aerosil R972V manufactured by Nippon Aerosil Co., Ltd.): 11 parts by mass

Ethanol: 89 parts by mass

Among the following components for a microparticle-additive liquid, methylene chloride was put into a dissolution tank, and the prepared microparticle-dispersion liquid was added slowly at the following addition amount under sufficient stirring. The mixture was dispersed by means of an attritor so that the secondary particles of the microparticles each have a predetermined size, and the dispersion was filtered by a Finemet NF (manufactured by Nippon Seisen Co., Ltd.) to give a microparticle-additive liquid.

(Microparticle-Additive Liquid)

Methylene chloride: 99 parts by mass

Microparticle-dispersion liquid: 5 parts by mass

Among the following components for a major dope, methylene chloride and ethanol were put into a pressurization-dissolution tank. Cellulose triacetate, and the prepared microparticle-additive liquid were then put into the tank under stirring, and the mixture was completely dissolved by heating and stirring. The obtained solution was filtered by using Azumi filter paper No. 244 manufactured by Azumi Filter Paper Co., Ltd. to prepare a major dope.

(Composition of Major Dope)

Methylene chloride: 520 parts by mass

Ethanol: 45 parts by mass

Cellulose triacetate (cellulose triacetate synthesized from linter cotton, acetyl group substitution degree: 2.88, Mn=150,000, Mw=300,000): 100 parts by mass

Microparticle-additive liquid: 1 part by mass

Secondly, the major dope was homogeneously casted on a stainless band supporting body by using a belt casting device. The solvent was evaporated on the stainless band supporting body until the amount of the residual solvent became 100%, and the resultant was peeled from the stainless band supporting body. The solvent was evaporated from the web of the cellulose ester film at 35° C., and the cellulose ester film was slit into 1.65 m width and dried at a drying temperature of 160° C. while drawing by means of a tenter by 1.15 times in the TD direction (the width direction of the film) and by 1.01 times in the MD direction (the longitudinal direction of the film). The amount of the residual solvent when the drying was initiated was 20%. The film was then dried for 15 minutes while the film was transported in a drying device at 120° C. by means of many rollers and slit into 1.33 m width, the both ends of the film were subjected to a knurling processing at a width of 10 mm and a height of 10 μm, and the film was wound around a winding core, whereby supporting body 1 with a film thickness 50 μm as a comparative example was prepared.

<Preparation of supporting body 2 (DAC; Comparative Example)>

Supporting body 2 as a comparative example was prepared in a similar manner to that for the preparation of supporting body 1, except that the cellulose triacetate was changed to a cellulose diacetate (DAC) having an acetyl substitution degree of 2.42, Mn=55,000 and Mw=165,000.

<Preparation of Supporting Body 3 (CAP; Comparative Example)>

Supporting body 3 as a comparative example was prepared in a similar manner to that for the preparation of supporting body 1, except that the cellulose triacetate was changed to a cellulose acetate propionate (product name: CAP482-20, manufactured by Eastman Chemical, acetyl group substitution degree: 0.2, propionyl group substitution degree: 2.56, total acyl group substitution degree: 2.76, Mn:70,000, Mw: 220,000).

<Preparation of Supporting Body 4 (Substituent; Present Invention)>

Supporting body 4, in accordance with embodiments of the invention, was prepared in a similar manner to that for the preparation of supporting body 1, except that the cellulose triacetate was changed to the following cellulose derivative 1 (Synthesis Example 1).

### Synthesis Example 1

50 g of cellulose (manufactured by Nippon Paper Industries Co., Ltd.: KC Flock W300) and 1 L of dimethylacetamide were weighed and put into a 3 L three-necked flask equipped with a mechanical stirrer, a thermometer, a cooling tube and a dropping funnel, and stirred at 120° C. for 1 hour under a nitrogen airflow. 150 g of lithium chloride was added and stirred for 1 hour while cooling. The reaction liquid was returned to room temperature, 220 g of pyridine was then added, a mixed liquid of 40 g of acetyl chloride and 322 g of benzoyl chloride was further added dropwise at room temperature, and the mixture was stirred at 100° C. for 3 hours. When the reaction solution was put into 10 L of methanol under vigorous stirring, a white solid was precipitated. The white solid was separated by filtration by aspiration filtration, dispersion washing was conducted three times with 2 L of methanol. The obtained white solid was vacuum dried at 100° C. for 6 hours to give intended cellulose derivative 1 as a white powder body (88 g).

The substitution degrees of cellulose derivative 1 (represented as Bz/CE in the table) were an acetyl group (Ac group) substitution degree of 0.88 and a benzoyl group (Bz group) substitution degree of 2.0. Furthermore, the molecular weights were Mn: 90,000 and Mw: 280,000.

<Preparation of Supporting Body 5 (Substituent; Present Invention)>

Supporting body 5, in accordance with embodiments of the invention, was prepared in a similar manner to that for the preparation of supporting body 1, except that the cellulose triacetate was changed to the following cellulose derivative 2 (Synthesis Example 2).

### Synthesis Example 2

50 g of cellulose having an acetyl group substitution degree of 2.15 (manufactured by Nippon Paper Industries Co., Ltd.: KC Flock W300) and 100 mL of pyridine were respectively added to a 3 L three-necked flask equipped with a mechanical stirrer a thermometer, a cooling tube and a dropping funnel at room temperature. 120 g of benzoyl chloride was then added dropwise slowly, and further stirred at 80° C. for 5 hours. After the reaction, the reactant was allowed to cool until the temperature returned to room temperature, and the reaction solution was put into 20 L of methanol under vigorous stirring, whereby a white solid was precipitated. The white solid was separated by filtration by aspiration filtration, and washed three times with a large amount of methanol. The obtained white solid was dried overnight at 60° C., and vacuum-dried at 90° C. for 6 hours to give cellulose derivative 2.

The substitution degrees of the substituents of the glucose backbone of the above-mentioned cellulose derivative 2 were measured according to the method described in Cellulose Communication 6, 73-79 (1999) and Chirality 12 (9), 670-674 by ¹H-NMR and ¹³C-NMR, and the average values thereof were obtained. As a result, the substitution degree of the benzoate, which is a substituent having a multiple bond, was 0.73, the substitution degree of the acetyl group was 2.15, and the total substitution degree was 2.88. Furthermore, the molecular weights of cellulose derivative 2 were Mn: 60,000 and Mw: 200,000.

<Preparation of Supporting Body 6 (Substituent; Present Invention)>

Supporting body 6, in accordance with embodiments of the invention, was prepared in a similar manner to that for the preparation of supporting body 1, except that the cellulose triacetate was changed to cellulose derivative 3 (Synthesis Example 3).

### Synthesis Example 3

50 g of cellulose having an acetyl group substitution degree of 2.42 (manufactured by Nippon Paper Industries Co., Ltd.: KC Flock W300) and 100 mL of pyridine were respectively added to a 3 L three-necked flask equipped with a mechanical stirrer a thermometer, a cooling tube and a dropping funnel and stirred at room temperature. To this resultant was added dropwise slowly 60 g of phenyl chloroformate, and the mixture was stirred at 80° C. for 5 hours. After the reaction, the reactant was allowed to cool until the temperature returned to room temperature, and the reaction solution was put into 20 L of methanol under vigorous stirring, whereby a white solid was precipitated. The white solid was separated by filtration by aspiration filtration, and washed three times with a large amount of methanol. The obtained white solid was dried overnight at 60° C., and vacuum-dried at 90° C. for 6 hours to give cellulose derivative 3.

The acetyl group substitution degree of the above-mentioned cellulose derivative 3 was 2.42, the substitution degree of the phenyloxycarbonyl group (represented as Poc group in the table) was 0.46, and the total substitution degree was 2.88. Furthermore, the molecular weights of cellulose derivative 3 were Mn: 70,000 and Mw: 250,000.

<Preparation of Supporting Body 7 (Crosslinking; Present Invention)>

Supporting body 7, in accordance with embodiments of the invention, was prepared in a similar manner to that for the preparation of supporting body 2, except that 1 part by mass of hexamethylene diisocyanate was added to the dope composition, and a heat treatment at 150° C. for 30 minutes was conducted after the film formation.

<Preparation of Supporting Body 8 (Crosslinking; Present Invention)>

Supporting body 8, in accordance with embodiments of the invention, was prepared in a similar manner to that for the preparation of supporting body 2, except that 12 parts by mass of the following compound A was added to the dope composition, and a heat treatment at 150° C. for 30 minutes was conducted after the film formation.

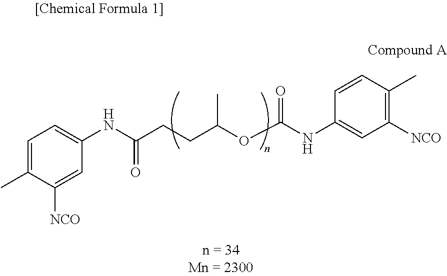

<Preparation of Supporting Body 9 (Crosslinking; Present Invention)>

Supporting body 9, in accordance with embodiments of the invention, was prepared in a similar manner to that for the preparation of supporting body 1, except that 5 parts by mass of Blenmer PDE600 (manufactured by Nippon Oil & Fats Co., Ltd.: dimethacrylate of polyethylene glycol) and 1 part by mass of Irgacure 907 (manufactured by BASF Japan) were added to the dope composition, and an ultraviolet irradiation treatment at an illuminance of an irradiation part of 500 mW/cm² and an irradiation amount of 1,000 mJ/cm² was conducted by using an ultraviolet lamp immediately before winding the supporting body.

<Preparation of Supporting Body 10 (Resin Mixing; Present Invention)>

Supporting body 10, in accordance with embodiments of the invention, was prepared in a similar manner to that for the preparation of supporting body 1, except that 25 parts by mass of a polyethylene glycol (represented as PEG: Mw; 2,000) was added to the dope composition.

<Preparation of Supporting Body 11 (Resin Mixing; Present Invention)>

Supporting body 11, in accordance with embodiments of the invention, was prepared in a similar manner to that for the preparation of supporting body 1, except that 25 parts by mass of a polyethylene glycol (Mw; 80,000) was added to the dope composition.

<Preparation of Supporting Body 12 (Resin Mixing; Present Invention)>

Supporting body 12, in accordance with embodiments of the invention, was prepared in a similar manner to that for the preparation of supporting body 2, except that 25 parts by mass of a polyethylene glycol (Mw; 80,000) was added to the dope composition.

<Preparation of Supporting Body 13 (Resin Mixing; Present Invention)>

Supporting body 13, in accordance with embodiments of the invention, was prepared in a similar manner to that for the preparation of supporting body 3, except that 25 parts by mass of a polyethylene glycol (represented as PEG: Mw; 2,000) was added to the dope composition.

<Preparation of Supporting Body 14 (Resin Mixing; Present Invention)>

Supporting body 14, in accordance with embodiments of the invention, was prepared in a similar manner to that for the preparation of supporting body 3, except that 25 parts by mass of a polyethylene glycol (Mw; 20,000) was added to the dope composition.

<Preparation of Supporting Body 15 (Resin Mixing; Present Invention)>

Supporting body 15, in accordance with embodiments of the invention, was prepared in a similar manner to that for the preparation of supporting body 3, except that 25 parts by mass of a polyethylene glycol (Mw; 80,000) was added to the dope composition.

<Preparation of Supporting Body 16 (Resin Mixing; Present Invention)>

Supporting body 16, in accordance with embodiments of the invention, was prepared in a similar manner to that for the preparation of supporting body 3, except that 25 parts by mass of a polyethylene glycol (Mw; 300,000) was added to the dope composition.

<Preparation of Supporting Body 17 (Resin Mixing; Present Invention)>

Supporting body 17, in accordance with embodiments of the invention, was prepared in a similar manner to that for the preparation of supporting body 3, except that 5 parts by mass of a polyethylene glycol (Mw; 80,000) was added to the dope composition.

<Preparation of Supporting Body 18 (Resin Mixing; Present Invention)>

Supporting body 18, in accordance with embodiments of the invention, was prepared in a similar manner to that for the preparation of supporting body 3, except that 40 parts by mass of a polyethylene glycol (Mw; 80,000) was added to the dope composition.

<Preparation of Supporting Body 19 (Resin Mixing; Present Invention)>

Supporting body 19, in accordance with embodiments of the invention, was prepared in a similar manner to that for the preparation of supporting body 2, except that 25 parts by mass of a polyvinyl pyrrolidone (Mw; 8,000) was added to the dope composition.

<Preparation of Supporting Body 20 (Resin Mixing; Present Invention)>

Supporting body 20, in accordance with embodiments of the invention, was prepared in a similar manner to that for the preparation of supporting body 3, except that 25 parts by mass of a polyvinyl acetate (Mw; 100,000) was added to the dope composition.

<Preparation of Supporting Body 21 (Substituent+Aromatic Compound; Present Invention)>

Supporting body 21, in accordance with embodiments of the invention, was prepared in a similar manner to that for the preparation of supporting body 4, except that 5 parts by mass of the following compound B was further added to the dope composition as an additive.

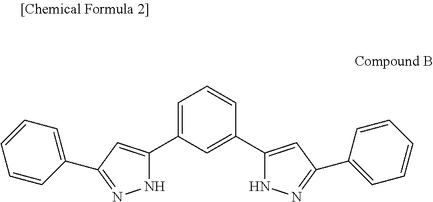 [SMILES: c1ccc(-c2cc(-c3cccc(-c4cc(-c5ccccc5)n[nH]4)c3)[nH]n2)cc1]

### <Preparation of Supporting Body 22 (Crosslinking+Resin Mixing; Present Invention)>

Supporting body 22, in accordance with embodiments of the invention, was prepared in a similar manner to that for the preparation of supporting body 9, except that 5 parts by mass of Blenmer PPE600 (manufactured by Nippon Oil & Fats Co., Ltd.: dimethacrylate of polypropylene glycol) was used instead of Blenmer PDE600 (manufactured by Nippon Oil & Fats Co., Ltd.) in the dope composition, and 25 parts by mass of a polyethylene glycol (Mw: 2,000) was further added.

<Preparation of Supporting Body 23 (Crosslinking+Resin Mixing; Present Invention)>

Supporting body 23, in accordance with embodiments of the invention, was prepared in a similar manner to that for the preparation of supporting body 22, except that 25 parts by mass of a polyethylene glycol (Mw: 80,000) was added to the dope composition instead of a polyethylene glycol (Mw: 2,000).

<Preparation of Supporting Body 24 (Resin Mixing; Present Invention)>

Supporting body 24, in accordance with embodiments of the invention, was prepared in a similar manner to that for the preparation of supporting body 3, except that 25 parts by mass of a PEG-PPG block copolymer (manufactured by NOF Corporation: Unilub 70DP-950B, average molecular weight 13,000) was added to the dope composition.

<Preparation of Optical Film A; Multilayer Film Infrared Ray Reflective Film>

As an optical functional layer, the infrared ray reflective film shown in FIG. 1, in which high refractive index layers each including a first water-soluble binder resin and first metal oxide particles, and low refractive index layers each including a second water-soluble binder resin and second metal oxide particles are alternately stacked, was prepared as follows.

Primer layer application liquid 1 was applied onto each of supporting bodies 1 to 24 by an extrusion coater so as to be 15 ml/m², passed through a windless zone at 50° C. (1 second) after the application, and dried at 120° C. for 30 seconds to give a supporting body on which a primer layer had been applied.

<Preparation of Primer Layer Application Liquid 1>

### Deionized Gelatin: 10 g

Pure water: 30 ml
Acetic acid: 20 g
The following crosslinking agent: 0.2 mol/g gelatin
The following nonionic fluorine-containing surfactant: 0.2 g

These were adjusted to 1,000 ml with an organic solvent of methanol/acetone=2/8 to prepare primer layer application liquid 1.

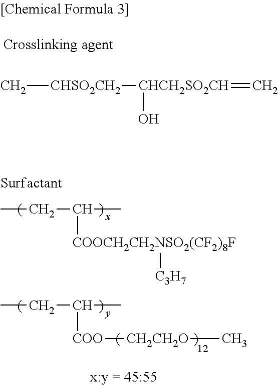

### <Preparation of Deionized Gelatin>

Ossein was subjected to a lime treatment, washing with water and a neutralizing treatment to remove lime, and this ossein was subjected to an extraction treatment in hot water at 55 to 60° C. to give ossein gelatin. The obtained ossein gelatin aqueous solution was subjected to anion-cation ion exchange on a mixed bed of an anion exchange resin (Diaion PA-31G) and a cation exchange resin (Diaion PK-218).

[Formation of Infrared Ray Reflective Layer]

Using a slide hopper application device (slide coater) capable of multi-layer coating, application liquid L1 for the low refractive index layer and the application liquid H1 for the high refractive index layer were applied by simultaneous multi-layer coating onto the above-mentioned supporting body on which the primer layer had been applied, which was warmed to 45° C., while keeping the application liquids at 45° C., to form 11 layers in total, in which 6 low refractive index layers and 5 high refractive index layers had been alternately stacked, so that the film thickness at drying of each of the high refractive index layers and low refractive index layers became 130 nm.

Immediately after the application, the layers were set by being blown with cold air of 5° C. for 5 minutes. Thereafter the layers were dried by blowing with hot air of 80° C., whereby an infrared ray reflective layer formed of 11 layers was formed. Furthermore, the following HC layer 1 was formed on the infrared ray reflective layer to give an infrared ray reflective film A.

[Preparation of Application Liquid L1 for Low Refractive Index Layer]

Firstly, 680 parts of an aqueous solution of 10% by mass of colloidal silica (Snowtex (registered trademark) OXS, manufactured by Nissan Chemical Industries Co., Ltd.) as the second metal oxide particles, 30 parts of an aqueous solution of 4.0% by mass of a polyvinyl alcohol (PVA-103 manufactured by Kuraray Co., Ltd.: polymerization degree: 300, saponification degree: 98.5 mol %) and 150 parts of an aqueous solution of 3.0% by mass of boric acid were mixed and dispersed. Pure water was added, whereby 1,000 parts as a whole of colloidal silica dispersion liquid L1 was prepared.

Subsequently, the obtained colloidal silica dispersion liquid L1 was heated to 45° C., and 760 parts of an aqueous solution of 4.0% by mass of a polyvinyl alcohol (manufactured by Japan VAM & POVAL Co., Ltd., JP-45: polymerization degree 4,500, saponification degree: 86.5 to 89.5 mol %) as polyvinyl alcohol (B) was sequentially added under stirring. Thereafter, 40 parts of an aqueous solution of 1% by mass of a betaine-based surfactant (Sofdazoline (registered trademark) LSB-R manufactured by Kawaken Fine Chemicals Co., Ltd.) was added, whereby application liquid L1 for low refractive index layers was prepared.

[Preparation of Application Liquid H1 for High Refractive Index Layers]

### (Preparation of Rutile Type Titanium Oxide as Cores for Core-Shell Particles)

Titanium oxide hydrate was suspended in water to prepare an aqueous suspension liquid of titanium oxide so that the concentration in terms of TiO₂ became 100 g/L. 30 L of an aqueous sodium hydroxide solution (concentration: 10 mol/L) was added to 10 L (liter) of the suspension liquid under stirring, and the liquid was heated to 90° C. and aged for 5 hours. The liquid was then neutralized by using hydrochloric acid, filtered, and then washed with water.

Incidentally, in the above-mentioned reaction (treatment), the titanium oxide hydrate as a raw material was obtained by a thermal hydrolysis treatment of an aqueous titanium sulfate solution according to a known technology.

The titanium compound that had undergone the above-mentioned base treatment was suspended in pure water so that the concentration in terms of TiO₂ became 20 g/L. 0.4 mol % with respect to the amount of TiO₂ of citric acid was added thereto under stirring. The mixture was then heated, and at the time when the temperature of the mixed sol liquid has become 95° C., concentrated hydrochloric acid was added so that the hydrochloric acid concentration became 30 g/L. The liquid was stirred for 3 hours while the liquid temperature was maintained at 95° C. to prepare a titanium oxide sol liquid.

When the pH and zeta potential of the obtained titanium oxide sol liquid were measured as mentioned above, the pH was 1.4, and the zeta potential was +40 mV. Furthermore, when the particle size was measured by a Zetacizer Nano manufactured by Malvern, the monodispersion degree was 16%.

Furthermore, the titanium oxide sol liquid was dried at 105° C. for 3 hours to give powder body microparticles of titanium oxide. Using Type JDX-3530 manufactured by JEOL Datum, the powder body microparticles were subjected to an X-ray diffraction measurement, and confirmed to be rutile type titanium oxide microparticles. Furthermore, the volume average particle size of the microparticles was 10 nm.

Furthermore, 20.0% by mass of a titanium oxide sol aqueous dispersion liquid containing the obtained rutile type titanium oxide microparticles having an average particle size of 10 nm was added to 4 kg of pure water to give a sol liquid to be core particles.

(Preparation of Core-Shell Particles by Shell Coating)

0.5 kg of the 10.0% by mass titanium oxide sol aqueous dispersion liquid was added to 2 kg of pure water, and the mixture was heated to 90° C. Subsequently, 1.3 kg of an aqueous silicic acid solution, which was prepared so as to have a concentration in terms of SiO₂ of 2.0% by mass, was gradually added, the mixture was subjected to a heat treatment in an autoclave at 175° C. for 18 hours, and further concentrated to give a sol liquid (solid content concentration: 20% by mass) of core-shell particles (average particle size: 10 nm) containing titanium oxide having a rutile type structure as core particles and SiO₂ as a coating layer.

(Preparation of Application Liquid H1 for High Refractive Index Layers)

28.9 parts of the sol liquid containing core-shell particles as the first metal oxide particles having a solid content concentration of 20.0% by mass obtained above, 10.5 parts of a 1.92% by mass aqueous citric acid solution, 2.0 parts of an aqueous solution of a 10% by mass aqueous solution of a polyvinyl alcohol (PVA-103 manufactured by Kuraray Co., Ltd.: polymerization degree: 300, saponification degree: 98.5 mol %), and 9.0 parts of a 3% by mass aqueous boric acid solution were mixed to prepare core-shell particle dispersion liquid H1.

Subsequently, 16.3 parts of pure water and 33.5 parts of an aqueous solution of a 5.0% by mass aqueous solution of a polyvinyl alcohol (PVA-124 manufactured by Kuraray Co., Ltd., polymerization degree: 2,400, saponification degree: 98 to 99 mol %) as polyvinyl alcohol (A) were added while the core-shell dispersion liquid H1 was stirred. Furthermore, 0.5 part of a 1% by mass aqueous solution of a betaine-based surfactant (Sofdazoline (registered trademark) LSB-R) manufactured by Kawaken Fine Chemicals Co., Ltd.) was added, and 1,000 parts as a whole of application liquid H1 for the high refractive index layers was prepared by using pure water.

<Formation of Hard Coat Layer (HC Layer 1)>

Beamset 577 (manufactured by Arakawa Chemical Industries, Ltd.) was used as an ultraviolet curable resin, and methylethylketone was added as a solvent. Furthermore, preparation was conducted so that the total solid content became 40 parts by mass by adding 0.08% by mass of a fluorine-based surfactant (trade name: Futargent (registered trademark) 650A, manufactured by NEOS Co., Ltd.), whereby application liquid A for a hard coat layer was prepared.

The application liquid A for a hard coat layer prepared above was applied onto an infrared ray reflective layer by a gravure coater under a condition that gives a dry layer thickness of 5 μm, dried at a drying interval temperature of 90° C. for 1 minute, and the hard coat layer was cured by using an ultraviolet lamp at an illuminance of an irradiation part of 100 mW/cm² and an irradiation amount of 0.5 J/cm², whereby a hard coat layer was formed.

<Preparation of Optical Film B; Ag Thin Film Infrared Ray Reflective Film>

An optical film that reflects infrared ray, on which a metal thin film is disposed as an optical functional layer, was prepared as follows.

A primer layer having a thickness of 1 μm was formed on each of supporting bodies 1 to 24, by filtering the following primer layer application liquid 2 with a polypropylene filter having a pore diameter of 0.4 μm to prepare primer layer application liquid 2, this was applied by using a microgravure coater and dried at 90° C., and the application layer was cured by using an ultraviolet lamp at an illuminance of an irradiation part of 100 mW/cm² and an irradiation amount of 100 mJ/cm².

A heat ray reflective layer having a thickness of 15 nm was formed on the primer layer by using a sputtering target material containing 2% by mass of gold in silver. Furthermore, an acrylic-based resin “Opstar 27535 (manufactured by JSR Corporation)” was applied onto the heat ray reflective layer by using a microgravure coater and dried at 90° C., and the applied layer was cured by using a ultraviolet lamp at an illuminance of an irradiation part of 100 mW/cm² and an irradiation amount of 100 mJ/cm² to form a hard coat layer having a thickness of 0.8 μm, whereby infrared ray reflective film B was prepared.

(Primer Layer Application Liquid 2)

The following materials were stirred and mixed to give primer layer application liquid 2.

Acrylic monomer; KAYARAD DPHA (dipentaerythritol hexaacrylate, manufactured by Nippon Kayaku Co., Ltd.): 200 parts by mass

Irgacure 184 (manufactured by BASF Japan): 20 parts by mass

Propylene glycol monomethyl ether: 110 parts by mass

Ethyl acetate: 110 parts by mass

### <<Evaluation>>

Using supporting bodies 1 to 24 prepared as above, the following evaluations were conducted.

<Rate of Enhancement of Breaking Elongation>

For each supporting body, five films cut into a width of 25 mm in the film formation direction (MD direction) and five films cut into a width of 25 mm in the width direction (TD direction) were respectively prepared and left under an environment at 23° C. and 55% RH for 24 hours, and the films were subjected to a tensile test by using a Shimadzu Autograph AGS-1000 (manufactured by Shimadzu Corporation) under an environment at 23° C. and 55% RH at a distance between chucks of 100 mm and a tensile velocity of 300 mm/min, breaking elongations were measured by the following formula, and an average value of the ten sheets was deemed as a breaking elongation.

Breaking elongation (%)=(L−Lo)/Lo×100

Lo: sample length before test L: sample length at break

As a result, the breaking elongation of supporting body 1 (TAC) was 30%, the breaking elongation of supporting body 2 (DAC) was 30%, and the breaking elongation of supporting body 3 (CAP) was 35%.

Each of the breaking elongations of supporting bodies 4 to 24 was compared with the breaking elongation of a similar kind of cellulose derivative whose breaking elongation had not been enhanced, and the enhance rate of the breaking elongation was obtained by the following formula.

Enhance rate of breaking elongation (%)=(breaking elongation of supporting body containing cellulose derivative whose breaking elongation has been enhanced)/(similar kind of cellulose derivative whose breaking elongation has not been enhanced)×100

Incidentally, for the enhance rates of the breaking elongations of cellulose derivative 1 to 3 used in supporting bodies 4 to 6 and 21, the breaking elongation of supporting body 1 (TAC) having an equivalent total substitution degree was used as a standard.

<Evaluation of Preserving Property>

Each of the obtained optical films was cut into a 10 cm square, and each sample was subjected to the following preservation acceleration test as an evaluation of the preserving property, and the haze and near infrared reflectance were measured by the following method.

Three thermo machines were prepared, each machine was adjusted to 85° C. (without humidification), −20° C., 60° C.—relative humidity 80%, and each sample was subjected to (85° C.—1 hour)→(−20° C.—1 hour)→(60° C.—relative humidity 80%—1 hour), and this was repeated three times (the transfer between the thermo machines was within 1 minute). Thereafter, light at an irradiation illuminance of 1 kW/m² was emitted for 15 hours by a metal halide lamp weather resistance tester (M6T manufactured by Suga Test Instruments Co., Ltd.). With setting these as one cycle, 3 cycles of preservation acceleration tests were conducted, and the haze and near infrared reflectance of each sample were measured again, and the changes before and after the preservation acceleration test were evaluated by the following indexes.

<Measurement of Haze Value>

The haze value after light irradiation (%) was obtained by measuring on 10 points at equal intervals in the width direction of the film under an environment at 23° C. and 55% RH by a haze meter (NDH2000 manufactured by Nippon Denshoku Industries Co., Ltd.), and obtaining the average value thereof.

<Measurement of Near Infrared Ray Reflectance>

Using a type U-4000 (manufactured by Hitachi, Ltd.) as a spectrometer, the reflectance of each infrared ray reflective film in an area at light wavelengths of from 800 to 1,400 nm was measured on 10 points at equal intervals in the width direction of the film under an environment at 23° C. and 55% RH, and the average value was obtained and deemed as a near infrared ray reflectance (%).

Width of haze change (represented as Δhaze in the table; unit: %); haze value after preservation acceleration test−haze value before preservation acceleration test

5: lower than 0.5%

4: 0.5% or more and lower than 1.0%

3: 1.0% or more and lower than 2.0%

2: 2.0% or more and lower than 5.0%

1: 5.0% or more and lower than 10.0%

0: 10.0 or more

Width of change in near infrared ray reflectance (represented as Δnear infrared ray reflectance in the table; unit: %); near infrared ray reflectance before preservation acceleration test−near infrared ray reflectance after preservation acceleration test

5: lower than 1%

4: 1% or more and lower than 3%

3: 3% or more and lower than 5%

2: 5% or more and lower than 10%

1: 10% or more and lower than 20%

0: 20% or more

The results of the above-mentioned evaluations are shown in Tables 1 and 2. Furthermore, in Tables 1 and 2, the evaluation results of above-mentioned width of haze change and width of change in near infrared ray reflectance were averaged and additionally described. A larger number indicates being more excellent on the whole.

TABLE 1

| | | | Chemical crosslinking | | | | | |
|---|---|---|---|---|---|---|---|---|
| | Cellulose | Modification | | Addition | | Blend | | |
| Sup- | derivative | Substituent | | amount | Method | | Addition | Breaking |
| porting | (100 | and | Cross- | parts | for | Thermo- | amount | elonga- |
| body | parts | degree of | linking | by | cross- | plastic | (parts by | tion |
| No. | by mass) | substitution | agent | mass) | linking | resin | mass) | (%) |
| 1 | TAC | — | — | — | — | — | — | 30 |
| 2 | DAC | — | — | — | — | — | — | 30 |
| 3 | CAP482-20 | — | — | — | — | — | — | 35 |
| 4 | Bz/CE | Ac group 0.88 | — | — | — | — | — | 50 |
| | | Bz group 2.0 | | | | | | |
| 5 | Bz/CE | Ac group 2.15 | — | — | — | — | — | 45 |
| | | Bz group 0.73 | | | | | | |
| 6 | Poc/CE | Ac group 2. 42 | — | — | — | — | — | 45 |
| | | Poc group 0.46 | | | | | | |
| 7 | DAC | — | HDI | 1 | Heat | — | — | 45 |
| 8 | DAC | — | Compound A | 12 | Heat | — | — | 60 |
| 9 | TAC | — | Blenmer | 5 | UV | — | — | 60 |
| | | | PDE600 | | | | | |
| 10 | TAC | — | — | — | — | PEG | 25 | 45 |
| | | | | | | (Mw: 2,000) | | |
| 11 | TAC | — | — | — | — | PEG | 25 | 70 |
| | | | | | | (Mw: 80,000) | | |
| 12 | DAC | — | — | — | — | PEG | 25 | 65 |
| | | | | | | (Mw: 80,000) | | |
| 13 | CAP482-20 | — | — | — | — | PEG | 25 | 45 |
| | | | | | | (Mw: 2,000) | | |
| 14 | CAP482-20 | — | — | — | — | PEG | 25 | 65 |
| | | | | | | (Mw: 20,000) | | |
| 15 | CAP482-20 | — | — | — | — | PEG | 25 | 75 |
| | | | | | | (Mw: 80,000) | | |

| | Enhance | Infrared reflective film | | | | | |
|---|---|---|---|---|---|---|---|
| | rate of | Multilayer film | | Ag thin film | | | |
| Supporting | breaking | | Δinfrared ray | | Δinfrared | | |
| body | elongation | | reflectance | | ray | Average | |
| No. | (%) | Δhaze | Δhaze | Δhaze | reflectance | value | Remarks |
| 1 | — | 0 | 1 | 1 | 1 | 0.75 | Comparative |
| | | | | | | | Example |
| 2 | — | 0 | 0 | 1 | 1 | 0.5 | Comparative |
| | | | | | | | Example |
| 3 | — | 0 | 1 | 1 | 1 | 0.75 | Comparative |
| | | | | | | | Example |
| 4 | 167 | 4 | 4 | 3 | 3 | 3.5 | Present |
| | | | | | | | Invention |
| 5 | 150 | 3 | 4 | 3 | 4 | 3.5 | Present |
| | | | | | | | Invention |
| 6 | 150 | 3 | 4 | 3 | 4 | 3.5 | Present |
| | | | | | | | Invention |
| 7 | 150 | 3 | 4 | 3 | 4 | 3.5 | Present |
| | | | | | | | Invention |
| 8 | 200 | 4 | 4 | 4 | 4 | 4 | Present |
| | | | | | | | Invention |
| 9 | 200 | 4 | 4 | 4 | 4 | 4 | Present |
| | | | | | | | Invention |
| 10 | 150 | 3 | 4 | 3 | 4 | 3.5 | Present |
| | | | | | | | Invention |
| 11 | 233 | 4 | 5 | 5 | 5 | 4.75 | Present |
| | | | | | | | Invention |
| 12 | 217 | 4 | 5 | 4 | 5 | 4.5 | Present |
| | | | | | | | Invention |
| 13 | 129 | 3 | 3 | 3 | 3 | 3 | Present |
| | | | | | | | Invention |
| 14 | 186 | 4 | 4 | 4 | 4 | 4 | Present |
| | | | | | | | Invention |
| 15 | 214 | 4 | 5 | 5 | 4 | 4.5 | Present |
| | | | | | | | Invention |

HDI: Hexamethylene diisocyanate

TABLE 2

| | | | Chemical crosslinking | | | | | |
|---|---|---|---|---|---|---|---|---|
| | Cellulose | Modification | | Addition | | Blend | | |
| | derivative | Substituent | | amount | Method | | Addition | Breaking |
| | (100 | and | Cross- | parts | for | Thermo- | amount | elonga- |
| Supporting | parts | degree of | linking | by | cross- | plastic | (parts by | tion |
| body No. | by mass) | substitution | agent | mass) | linking | resin | mass) | (%) |
| 16 | CAP482-20 | — | — | — | — | PEG | 25 | 80 |
| | | | | | | (Mw: 300,000) | | |
| 17 | CAP482-20 | — | — | — | — | PEG | 5 | 60 |
| | | | | | | (Mw: 80,000) | | |
| 18 | CAP482-20 | — | — | — | — | PEG | 40 | 60 |
| | | | | | | (Mw: 80,000) | | |
| 19 | DAC | — | — | — | — | Polyvinyl | 25 | 40 |
| | | | | | | pyrrolidone | | |
| | | | | | | (Mw: 8,000) | | |
| 20 | CAP482-20 | — | — | — | — | Polyvinyl acetate | 25 | 40 |
| | | | | | | (Mw: 100,000) | | |
| 21 | Bz/CE | Ac group 0.88 | — | — | — | (Compound B) | 5 | 60 |
| | | Bz group 2.0 | | | | | | |
| 22 | TAC | — | Blenmer | 5 | UV | PEG | 25 | 65 |
| | | | PPE600 | | | (Mw: 2,000) | | |
| 23 | TAC | — | Blenmer | 5 | UV | PEG | 25 | 80 |
| | | | PPE600 | | | (Mw: 80,000) | | |
| 24 | CAP482-20 | — | — | — | — | PEG-PPG block | 40 | 65 |
| | | | | | | copolymer | | |
| | | | | | | (Mw: 13,000) | | |

| | Enhance | | | | | | |
|---|---|---|---|---|---|---|---|
| | rate of | Infrared reflective film | | | | | |
| | breaking | Multilayer film | | Ag thin film | | | |
| | elonga- | | Δinfrared | | Δinfrared | | |
| Supporting | tion | | ray | | ray | Average | |
| body No. | (%) | Δhaze | reflectance | Δhaze | reflectance | value | Remarks |
| 16 | 229 | 4 | 5 | 5 | 5 | 4.75 | Present |
| | | | | | | | Invention |
| 17 | 171 | 3 | 4 | 4 | 4 | 3.75 | Present |
| | | | | | | | Invention |
| 18 | 171 | 4 | 4 | 3 | 4 | 3.75 | Present |
| | | | | | | | Invention |
| 19 | 133 | 3 | 4 | 3 | 3 | 3.25 | Present |
| | | | | | | | Invention |
| 20 | 114 | 3 | 3 | 3 | 3 | 3 | Present |
| | | | | | | | Invention |
| 21 | 200 | 4 | 4 | 4 | 4 | 4 | Present |
| | | | | | | | Invention |
| 22 | 217 | 4 | 5 | 5 | 4 | 4.5 | Present |
| | | | | | | | Invention |
| 23 | 267 | 5 | 5 | 5 | 5 | 5 | Present |
| | | | | | | | Invention |
| 24 | 186 | 4 | 4 | 4 | 4 | 4 | Present |
| | | | | | | | Invention |

It is understood from Tables 1 and 2 that the optical films using supporting bodies 4 to 24 of one or more embodiments of the invention, each having an enhanced breaking elongation, are excellent in preserving property, from the results of the width in haze change and the width of change in near infrared ray reflectance with respect to Comparative Examples.

As the method for enhancing the breaking elongation, a method for blending a thermoplastic resin having a molecular weight in a suitable amount with a cellulose derivative (supporting bodies 11, 12, 15 and 16) may be used. Furthermore, since a method for subjecting a cellulose derivative to a chemical crosslinking reaction and further adding a thermoplastic resin (supporting body 23) may be used, various methods for enhancing a breaking elongation may be used.

### INDUSTRIAL APPLICABILITY

The optical film of one or more embodiments of the invention is an optical film having an optical functional layer on a supporting body containing a cellulose derivative as a major component, wherein the supporting body does not cause cracks and the like even when the supporting body is exposed for a long period to a severe environment such that dew condensation and temperature change are repeated, and wherein the optical film provides an infrared ray reflective film in which the reflectance, transmittance and haze of the optical functional layer have been stabilized.

### REFERENCE SIGNS LIST

1: optical film
2: supporting body
ML, MLa, MLb: group of reflective layers
T₁ to Tₙ, Ta₁ to Taₙ, Tb₁ to Tbₙ: reflective layers
U: reflective layer unit

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1-9. (canceled)

10. An optical film having an optical functional layer on at least one surface of a film-like supporting body,
wherein the supporting body contains a cellulose derivative having an enhanced breaking elongation, and the supporting body has a breaking elongation of 110% or more of the breaking elongation of a supporting body containing a cellulose derivative whose breaking elongation is not enhanced.

11. The optical film according to claim 10, wherein the optical functional layer selectively allows the transmission of or shielding against light at a specific wavelength.

12. The optical film according to claim 10, wherein the optical functional layer is a layer that selectively reflects light at a specific wavelength and comprises high refractive index layers each containing a first water-soluble binder resin and first metal oxide particles, and low refractive index layers each containing a second water-soluble binder resin and second metal oxide particles, wherein the high refractive index layers and the low refractive index layers are alternately stacked.

13. The optical film according to claim 10, wherein the cellulose derivative having an enhanced breaking elongation is a partially chemical-crosslinked cellulose derivative.

14. The optical film according to claim 10, wherein the cellulose derivative having an enhanced breaking elongation is such that a part of the hydrogen atoms of the hydroxy groups remaining in the cellulose derivative, which is a major component of the supporting body, have been substituted with substituents, each of which is represented by the following general formula (1):
*-L-A General Formula (1)
(wherein L represents a simple bond, —CO—, —CONH—, —COO—, —SO2-, —SO2O—, —SO—, an alkylene group, an alkylene group or an alkynylene group; A represents an aryl group or a heteroaryl group; and the asterisk (*) represents a bonding point between the oxygen atom of the hydroxy group remaining in the cellulose derivative and L.)

15. The optical film according to claim 10, wherein the cellulose derivative having an enhanced breaking elongation is a mixture of a cellulose derivative and a thermoplastic resin, and the thermoplastic resin has a hydroxy group, an amide group, an ester group, an ether group, a cyano group or a sulfonyl group as a partial structure in the molecule.

16. The optical film according to claim 10, wherein the cellulose derivative is a cellulose ester.

17. The optical film according to claim 10, wherein the supporting body has a breaking elongation of 130% or more of the breaking elongation of the supporting body containing a cellulose derivative whose breaking elongation is not enhanced.

18. The optical film according to claim 10, wherein the supporting body has a breaking elongation of 150% or more of the breaking elongation of the supporting body containing a cellulose derivative whose breaking elongation is not enhanced.

19. The optical film according to claim 11, wherein the optical functional layer is a layer that selectively reflects light at a specific wavelength and comprises high refractive index layers each containing a first water-soluble binder resin and first metal oxide particles, and low refractive index layers each containing a second water-soluble binder resin and second metal oxide particles, wherein the high refractive index layers and the low refractive index layers are alternately stacked.

20. The optical film according to claim 11, wherein the cellulose derivative having an enhanced breaking elongation is a partially chemical-crosslinked cellulose derivative.

21. The optical film according to claim 11, wherein the cellulose derivative having an enhanced breaking elongation is such that a part of the hydrogen atoms of the hydroxy groups remaining in the cellulose derivative, which is a major component of the supporting body, have been substituted with substituents, each of which is represented by the following general formula (1):
*-L-A General Formula (1)
(wherein L represents a simple bond, —CO—, —CONH—, —COO—, —SO2-, —SO2O—, —SO—, an alkylene group, an alkylene group or an alkynylene group; A represents an aryl group or a heteroaryl group; and the asterisk (*) represents a bonding point between the oxygen atom of the hydroxy group remaining in the cellulose derivative and L.)

22. The optical film according to claim 11, wherein the cellulose derivative having an enhanced breaking elongation is a mixture of a cellulose derivative and a thermoplastic resin, and the thermoplastic resin has a hydroxy group, an amide group, an ester group, an ether group, a cyano group or a sulfonyl group as a partial structure in the molecule.

23. The optical film according to claim 11, wherein the cellulose derivative is a cellulose ester.

24. The optical film according to claim 11, wherein the supporting body has a breaking elongation of 130% or more of the breaking elongation of the supporting body containing a cellulose derivative whose breaking elongation is not enhanced.

25. The optical film according to claim 11, wherein the supporting body has a breaking elongation of 150% or more of the breaking elongation of the supporting body containing a cellulose derivative whose breaking elongation is not enhanced.

26. The optical film according to claim 12, wherein the cellulose derivative having an enhanced breaking elongation is a partially chemical-crosslinked cellulose derivative.

27. The optical film according to claim 12, wherein the cellulose derivative having an enhanced breaking elongation is such that a part of the hydrogen atoms of the hydroxy groups remaining in the cellulose derivative, which is a major component of the supporting body, have been substituted with substituents, each of which is represented by the following general formula (1):
*-L-A General Formula (1)
(wherein L represents a simple bond, —CO—, —CONH—, —COO—, —SO2-, —SO2O—, —SO—, an alkylene group, an alkylene group or an alkynylene group; A represents an aryl group or a heteroaryl group; and the asterisk (*) represents a bonding point between the oxygen atom of the hydroxy group remaining in the cellulose derivative and L.)

28. The optical film according to claim 12, wherein the cellulose derivative having an enhanced breaking elongation is a mixture of a cellulose derivative and a thermoplastic resin, and the thermoplastic resin has a hydroxy group, an amide group, an ester group, an ether group, a cyano group or a sulfonyl group as a partial structure in the molecule.

29. The optical film according to claim 12, wherein the cellulose derivative is a cellulose ester.
